(19) United States
(12) Patent Application Publication
(10) Pub. No.: US 2026/0072259 A1
(43) Pub. Date: Mar. 12, 2026

(54) OPTICAL SYSTEM, IMAGE PROJECTION APPARATUS, AND IMAGING APPARATUS

(71) Applicant: Panasonic Intellectual Property Management Co., Ltd., Osaka (JP)

(72) Inventors: Yasushi KOBAYASHI, Osaka (JP); Takuya IMAOKA, Kanagawa (JP)

(21) Appl. No.: 19/387,948

(22) Filed: Nov. 13, 2025

Related U.S. Application Data
(63) Continuation of application No. PCT/JP2024/022800, filed on Jun. 24, 2024.

(30) Foreign Application Priority Data
Jul. 6, 2023 (JP) 2023-111578

(51) Int. Cl. G02B 17/08; G02B 13/00; G03B 21/20; G03B 21/56

(52) U.S. Cl. CPC G02B 17/0812; G02B 13/0045; G03B 21/208; G03B 21/56

(57) ABSTRACT

An optical system has a reduction conjugate point on a reduction side and a magnification conjugate point on a magnification side, and has an intermediate imaging position conjugate with each of the reduction conjugate point and the magnification conjugate point inside. The optical system includes: a first sub-optical system including a plurality of lenses; and a second sub-optical system including a plurality of optical surfaces. A magnification conjugate plane including the magnification conjugate point is positioned in a direction of the first sub-optical system, from a viewpoint of the second sub-optical system. The plurality of optical surfaces include: a first transmitting surface; a second transmitting surface; a first reflecting surface; and a second reflecting surface. A first effective area through which a light flux passes in the first transmitting surface and a second effective area through which the light flux passes in the second transmitting surface do not overlap.

### CROSS REFERENCE TO RELATED APPLICATION

This application claims benefit of priority to International Application No. PCT/JP2024/022800, with an international filing date of Jun. 24, 2024, which claims priorities of Japanese Patent Application No. 2023-111578 filed on Jul. 6, 2023, the entire contents of which are incorporated herein by reference.

### BACKGROUND

### Technical Field

The present disclosure relates to an optical system with an intermediate imaging position in internal of the optical system. The present disclosure also relates to an image projection apparatus and an imaging apparatus using such an optical system.

### Background Art

JP 2020-42103 A discloses a projection optical system and an image projection apparatus using a cemented lens or a D-cut shape lens.

### SUMMARY

Referring to the fifth example (FIG. 8) of JP 2020-42103 A, the D-cut shape lens is a single optical element without any boundary surface, and the same optical surface is shared as the incident surface 40A and the emitting surface 40D. In such a configuration, the incident surface 40A and the emitting surface 40D are inseparable because there are no restrictions in directions in which the light reflects on the second reflecting surface 40C. Furthermore, because the emitting surface 40D needs to be a convex surface, the incident surface 40A, too, ends up being a convex surface. With such a convex incident surface 40A, in order to obtain the intermediate image Im1 at a predetermined position, the refractive optical system ends up having a large effective aperture stop. As a result, the total length of the optical system is increased, so that the image projection apparatus is increased in size.

The present disclosure provides an optical system enabling diagonal image projection or imaging, on a large screen with a short focal length. The present disclosure also provides an image projection apparatus and an imaging apparatus using such an optical system.

One aspect of the present disclosure provides an optical system having a reduction conjugate point on a reduction side and a magnification conjugate point on a magnification side, and having an intermediate imaging position conjugate with each of the reduction conjugate point and the magnification conjugate point inside, the optical system including:
a first sub-optical system including a plurality of lenses that are rotationally symmetric with respect to an optical axis, and an aperture stop between two lenses among the plurality of lenses; and
a second sub-optical system disposed on the magnification side of the first sub-optical system and including a plurality of optical surfaces,
in a direction of the optical axis from the first sub-optical system to the second sub-optical system, a magnification conjugate plane including the magnification conjugate point is positioned in a direction of the first sub-optical system, from a viewpoint of the second sub-optical system, and
the plurality of optical surfaces include: on a light path of a light flux between the first sub-optical system and the magnification conjugate point,
   a first transmitting surface located closest to the first sub-optical system;
   a second transmitting surface located closest to the magnification conjugate point;
   a first reflecting surface located closest to the first transmitting surface on the light path between the first transmitting surface and the second transmitting surface; and
   a second reflecting surface located closest to the second transmitting surface on the light path between the first transmitting surface and the second transmitting surface,
a light path from the first transmitting surface to the first reflecting surface and a light path from the second reflecting surface to the second transmitting surface intersect with each other, and
a first effective area through which a light flux passes in the first transmitting surface and a second effective area through which the light flux passes in the second transmitting surface do not overlap each other.

An image projection apparatus according to another aspect of the present disclosure includes: the optical system described above; and an image forming element configured to generate an image to be projected onto a screen via the optical system.

An imaging apparatus according to another aspect of the present disclosure includes: the optical system described above; and an imaging element configured to receive an optical image formed by the optical system and to convert the optical image into an electrical image signal.

With the optical system according to the present disclosure, it is possible to achieve an optical system giving a high degree of freedom in the optical design, and being advantageous in achieving a wider field of view.

### BRIEF DESCRIPTION OF DRAWINGS

FIG. 1 is a layout diagram illustrating an optical system 1 according to first example;

FIG. 2A is a perspective view illustrating a three-dimensional shape of the optical surfaces of a prism PM;

FIG. 2B illustrates part of light rays traveling inside the prism PM;

FIG. 3A is a cross-sectional view of the prism PM along a YZ plane;

FIG. 3B illustrates part of light rays traveling inside the prism PM;

FIG. 4A is a top view of the prism PM in a view in a Y direction;

FIG. 4B illustrates part of light rays traveling inside the prism PM;

FIG. 5A is a cross-sectional view illustrating the light flux closest to the optical axis OA, among the light fluxes internal of the prism PM, and the principal ray PR of the light flux;

FIG. 5B is a cross-sectional view illustrating a Y-direction intermediate image IMy, on a YZ plane;

FIG. 6A is a YZ cross-sectional view for explaining the definition of an angle θa of the direction at which the principal ray PR is reflected on a second reflecting surface R2;

FIG. 6B is a YZ cross-sectional view for explaining the definition of an angle θb of the direction at which the principal ray PR travels outside of the prism PM;

FIG. 7 is a plot of transverse aberrations in the optical system 1 according to first example;

FIG. 8 includes plots of transverse aberrations in the optical system 1 according to first example;

FIG. 9 is a diagram illustrating a layout of an optical system 1 according to second example;

FIG. 10 includes plots of transverse aberrations in the optical system 1 according to second example;

FIG. 11 includes plots of transverse aberrations in the optical system 1 according to second example;

FIG. 12 is a diagram illustrating a layout of an optical system 1 according to third example;

FIG. 13 includes plots of transverse aberrations in the optical system 1 according to third example;

FIG. 14 includes plots of transverse aberrations in the optical system 1 according to third example;

FIG. 15A is a layout diagram illustrating an example of diagonal upper-rearward projection onto a wall surface screen SR;

FIG. 15B is a layout diagram illustrating an example of diagonal lower-rearward projection onto the wall surface screen SR;

FIG. 15C is a layout diagram illustrating an example of diagonal upper-rearward projection onto a ceiling screen SR;

FIG. 15D is a layout diagram illustrating an example of diagonal lower-rearward projection onto a floor screen SR;

FIG. 16 is a block diagram illustrating an example of an image projection apparatus according to the present disclosure; and

FIG. 17 is a block diagram illustrating an example of an imaging apparatus according to the present disclosure.

### DETAILED DESCRIPTION

An embodiment will now be explained in detail with reference to drawings, as appropriate. However, descriptions more in detail than necessary may be omitted. For example, detailed descriptions of well-known matters or redundant descriptions of substantially the same configurations may be omitted. This is to avoid unnecessary redundancy in the following description, and to facilitate understanding of those skilled in the art.

Note that the applicant provides the accompanying drawings and the following description to facilitate those skilled in the art to fully understand the present disclosure, and the accompanying drawings and the following description are not intended to limit the subject matter defined in the claims in any way.

An optical system according to the example of the present disclosure will now be explained. Explained in the example is an example in which an optical system is used in a projector (an example of an image projection apparatus) in which incident light is spatially modulated by an image forming element, such as a liquid crystal or a digital micromirror device (DMD), on the basis of an image signal, and image light of an original image SA resultant of such spatial modulation is projected onto a screen. In other words, the optical system according to the present disclosure may be used in projecting an enlarged version of the original image SA that is on the image forming element, which is disposed on the reduction side, onto a screen, not illustrated, disposed on the extension line of the optical system on the magnification side. However, the surface to which the image is projected is not limited to a screen. The surface to which the image is projected also includes a wall, a ceiling, a floor, a window, or the like of a house, a store, a transportation such as a vehicle, or interior of the vehicle.

The optical system according to the present disclosure may also be used for collecting the light radiated from an object disposed on the extension line of the optical system on the magnification side, and to form an optical image of the object on the imaging surface of an imaging element that is disposed on the reduction side.

### First Embodiment

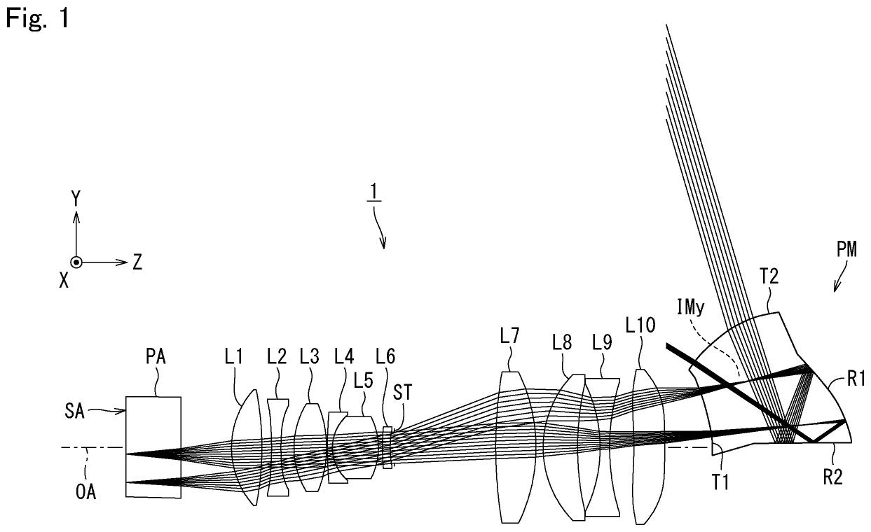

The optical system according to a first embodiment of the present disclosure will be described below with reference to FIGS. 1 to 14.

### First Example

FIG. 1 is a diagram illustrating a layout of an optical system 1 according to first example. The optical system 1 includes a first sub-optical system including a plurality of lens elements and an aperture stop ST, and a second sub-optical system including a plurality of optical surfaces. In FIG. 1, a reduction conjugate point, which is the image-forming position on the reduction side, is located on the left side of the optical axis OA, and a magnification conjugate point, which is the image-forming position on the magnification side, is located on the upper left side of the optical axis OA. The second sub-optical system is provided on the magnification side of the first sub-optical system.

In addition, inside the optical system 1, there is an intermediate imaging position that is conjugate with each of the reduction conjugate point and the magnification conjugate point. This intermediate imaging position has both of a Y-direction intermediate image IMy and an X-direction intermediate image IMx, inside the second sub-optical system. The Y-direction intermediate image IMy is illustrated in FIG. 1, but the X-direction intermediate image IMx is not illustrated.

The first sub-optical system includes an optical element PA and lens elements L1 to L10 that are disposed sequentially from the reduction side to the magnification side. The optical element PA represents an optical element such as a total internal reflection (TIR) prism, a prism for color separation or color combination, an optical filter, a parallel plate glass, a crystal low-pass filter, or an infrared cut filter. The reduction conjugate point is set to a predetermined distance from the reduction-side end face of the optical element PA, and the original image SA is installed at the reduction conjugate point.

The optical element PA has two transmitting surfaces that are flat and parallel with each other (surfaces 1, 2). The surface numbers will be referred to in the numerical examples to be described later. The lens element L1 has a biconvex shape (surfaces 3, 4). The lens element L2 has a biconcave shape (surfaces 5, 6). The lens element L3 has a biconvex shape (surfaces 7, 8). The lens element L4 has a negative meniscus shape, with a convex surface facing the reduction side (surfaces 9, 10). The lens element L5 has a biconvex shape (surfaces 11, 12). The lens element L6 has a negative meniscus shape, with a convex surface facing the reduction side (surfaces 13, 14). The lens element L7 has a biconvex shape (surfaces 16, 17). The lens element L8 has a positive meniscus shape, with a convex surface facing the reduction side (surfaces 18, 19). The lens element L9 has a biconcave shape (surfaces 20, 21). The lens element L10 has a biconcave shape (surfaces 22, 23). Each of these lens elements L1 to L10 is a rotationally symmetric lens the surfaces of which have shapes that are rotationally symmetric about the optical axis OA of the first sub-optical system, and the part where no light rays pass may be removed, as necessary.

The second sub-optical system includes a prism PM made of a transparent medium such as glass or synthetic resin. The prism PM has a plurality of optical surfaces. The plurality of optical surfaces include: on the light path of the light flux between the first sub-optical system and the magnification conjugate point, a first transmitting surface T1 located closest to the first sub-optical system; a second transmitting surface T2 located closest to the magnification conjugate point; and a first reflecting surface R1 and a second reflecting surface R2 located closest to the first transmitting surface T1 and to the second transmitting surface T2, respectively, on the light path between the first transmitting surface T1 and the second transmitting surface T2. The first transmitting surface T1 has a free-form surface, with a convex surface facing the magnification side (surface 24). The first reflecting surface R1 has a free-form surface, with a concave surface facing the direction in which the light ray of light being incident on the first reflecting surface R1 is reflected (surface 25). The second reflecting surface R2 has a free-form surface, with a convex surface facing the direction in which the light ray of light being incident on the second reflecting surface R2 is reflected (surface 26). The second transmitting surface T2 has a free-form surface, with a convex surface facing the magnification side (surface 27).

The aperture stop ST defines the range where the light flux is passed through the optical system 1, and is positioned between the reduction conjugate point and the intermediate imaging position mentioned above. As an example, the aperture stop ST is positioned between the lens element L6 and the lens element L7 (surface 15).

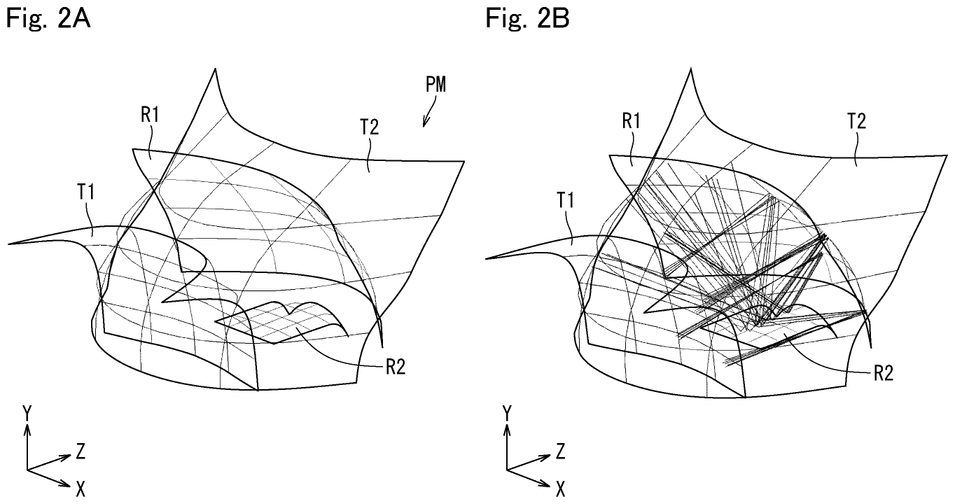

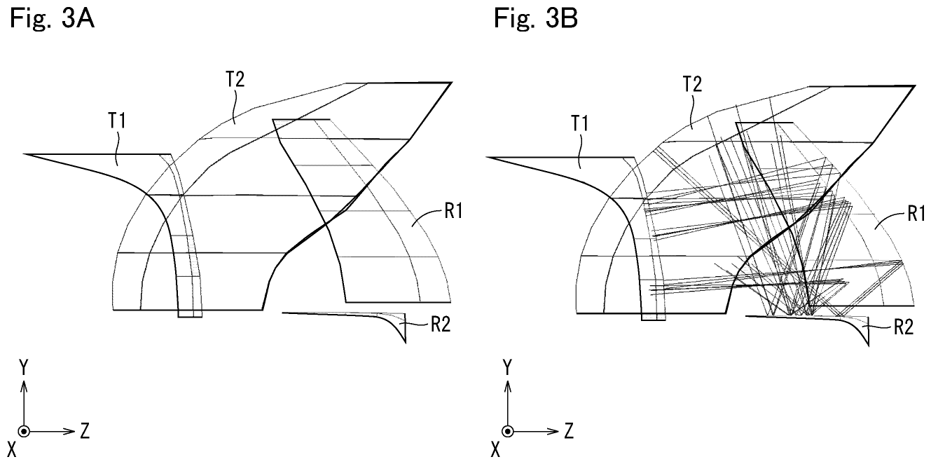

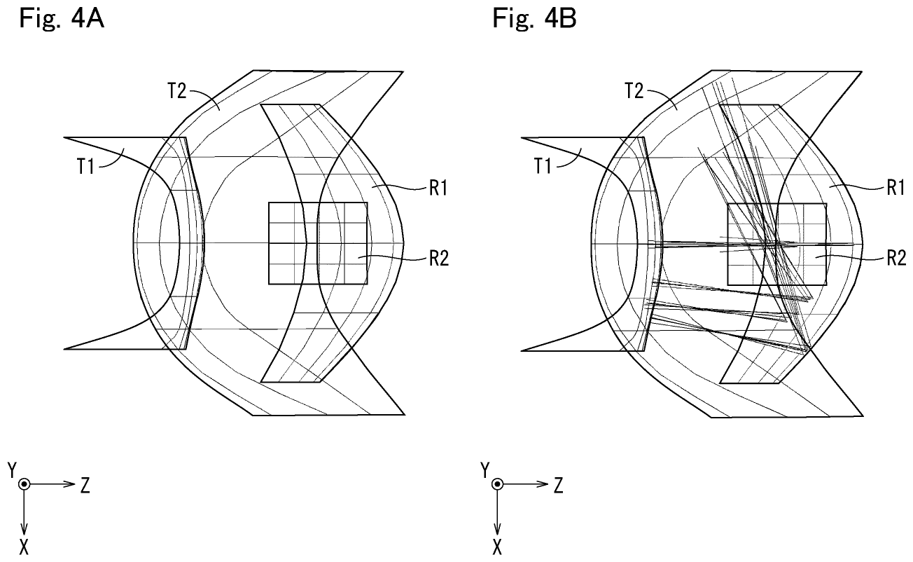

FIG. 2A is a perspective view illustrating three-dimensional shapes of the optical surfaces of the prism PM, and FIG. 2B illustrates part of light rays traveling inside the prism PM. For example, the first transmitting surface T1 is curved with the concave surface facing the −Z direction; the second transmitting surface T2 has a partial dome-like shape covering the other optical surfaces from above; the first reflecting surface R1 faces the first transmitting surface T1; and the second reflecting surface R2 faces the second transmitting surface T2. FIG. 3A is a cross-sectional view of the prism PM along the YZ plane, and FIG. 3B illustrates part of the light rays traveling inside the prism PM. FIG. 4A is a top view of the prism PM in a view from the Y direction, and FIG. 4B illustrates part of the light rays traveling inside the prism PM.

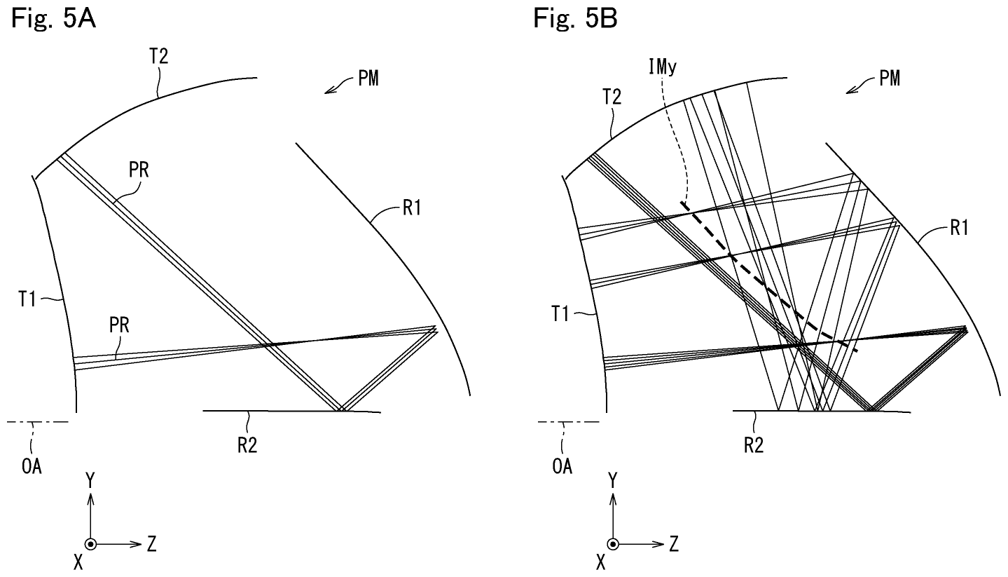

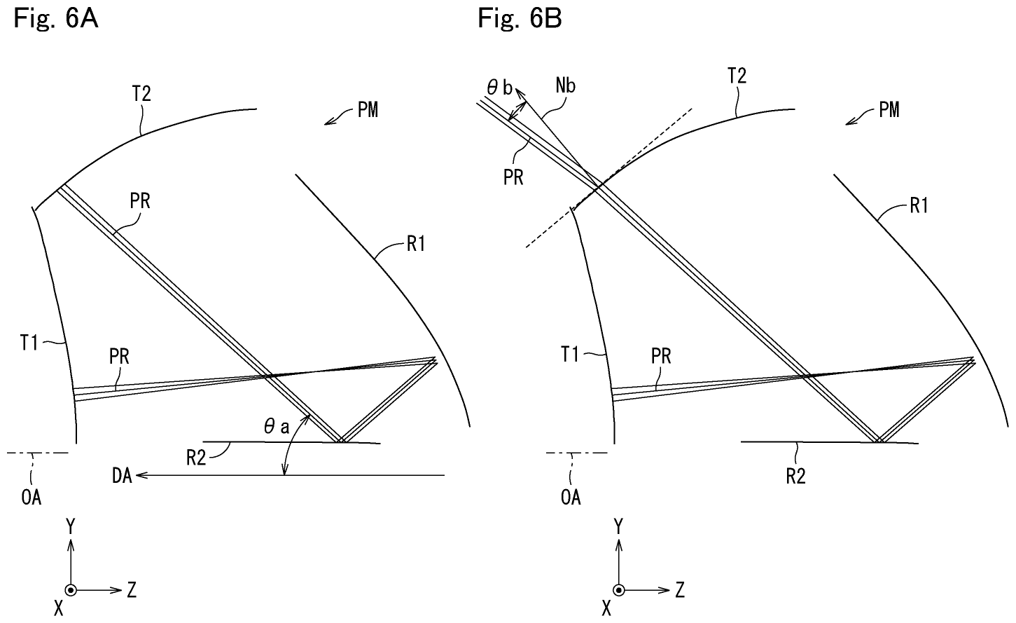

FIG. 5A is a YZ cross-sectional view illustrating the light flux closest to the optical axis OA inside the prism PM, and the principal ray PR of the light flux. FIG. 5B is a YZ cross-sectional view illustrating the Y-direction intermediate image IMy in the YZ plane. FIG. 6A is a YZ cross-sectional view for explaining the definition of an angle θa of the direction in which the principal ray PR is reflected by the second reflecting surface R2. FIG. 6B is a YZ cross-sectional view for explaining the definition of an angle θb of the direction in which the principal ray PR travels outside the prism PM. Details will be described later.

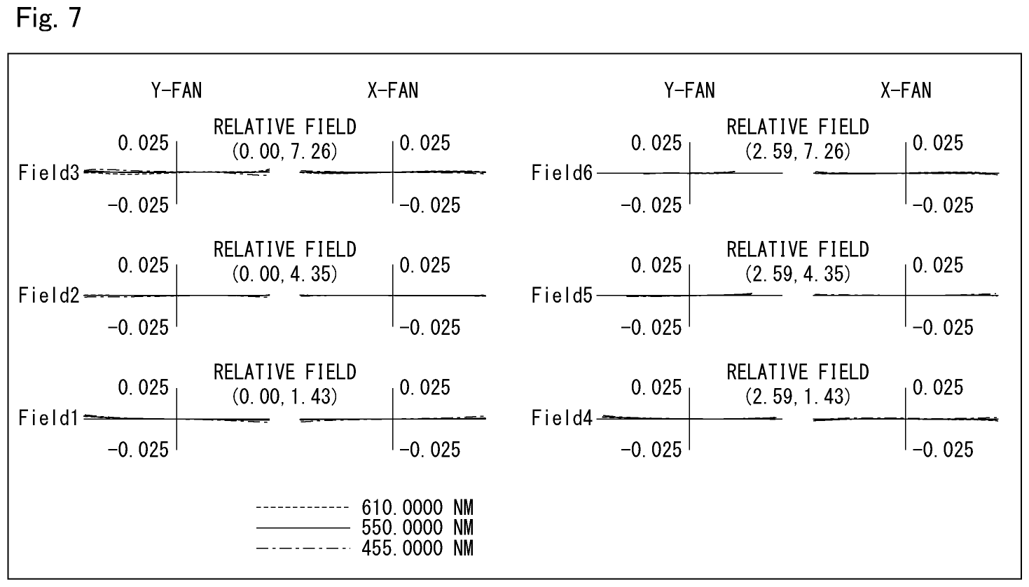

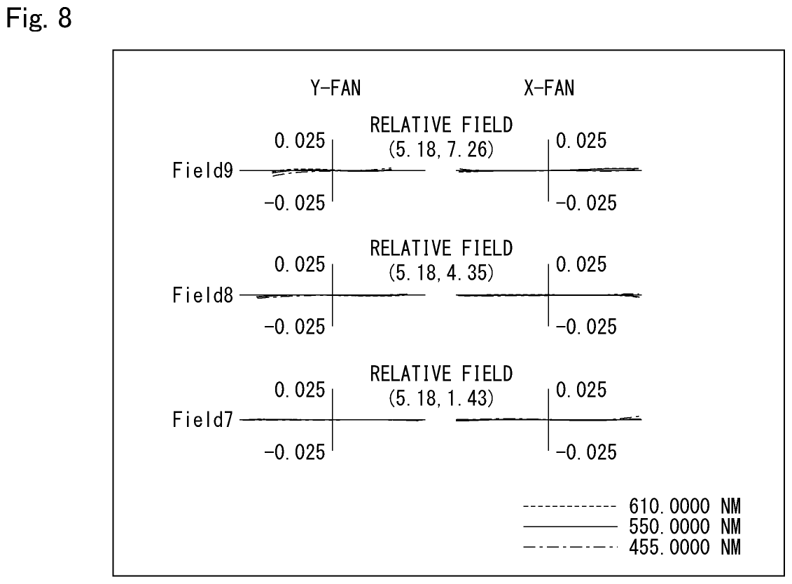

FIGS. 7 and 8 are plots of transverse aberrations in the optical system 1 according to first example. These plots correspond to the coordinates (X, Y)=(0.00,1.43), (0.00,4.35), (0.00,7.26), (2.59,1.43), (2.59,4.35), (2.59,7.26), (5.18, 1.43), (5.18,4.35), and (5.18,7.26), respectively, inside a first rectangular effective area at the reduction conjugate point. The solid line represents a wavelength of 550 nm; the broken line represents a wavelength of 610 nm, and the alternate long and short dash line represents a wavelength of 455 nm. From these plots, it can be seen that the optical system 1 according to first example exhibits excellent optical performance.

### Second Example

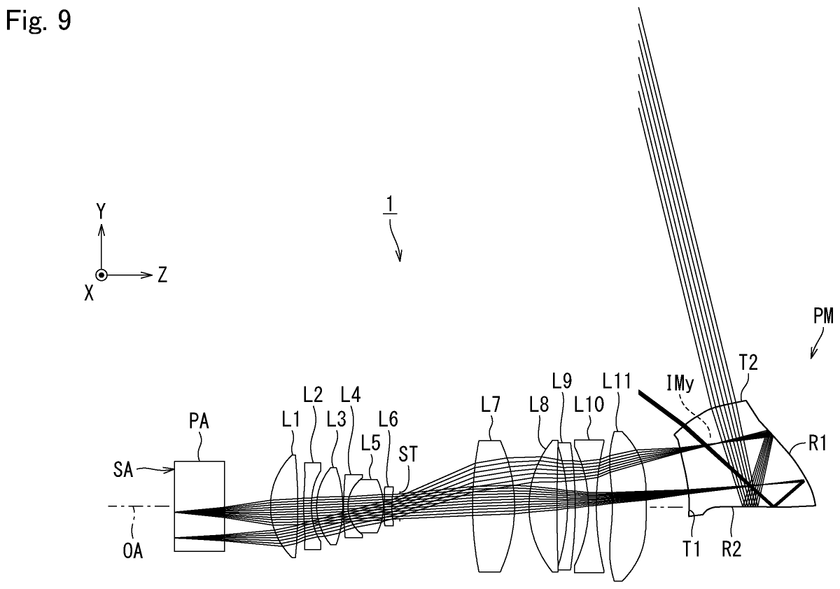

FIG. 9 is a diagram illustrating a layout of an optical system 1 according to second example. The optical system 1 has a configuration similar to that of first example, and redundant descriptions with first example will be omitted. The optical system 1 includes a first sub-optical system including a plurality of lens elements and an aperture stop ST, and a second sub-optical system including a plurality of optical surfaces. In FIG. 9, the reduction conjugate point, which is the image-forming position on the reduction side, is located on the left side of the optical axis OA, and the magnification conjugate point, which is the image-forming position on the magnification side, is located on the upper left side of the optical axis OA. The second sub-optical system is provided on the magnification side of the first sub-optical system.

In addition, inside the optical system 1, there is an intermediate imaging position that is conjugate with each of the reduction conjugate point and the magnification conjugate point. This intermediate imaging position has both of a Y-direction intermediate image IMy and an X-direction intermediate image IMx, inside the second sub-optical system. The Y-direction intermediate image IMy is illustrated in FIG. 9, but the X-direction intermediate image IMx is not illustrated.

The first sub-optical system includes the optical element PA and lens elements L1 to L11 that are disposed sequentially from the reduction side to the magnification side. The reduction conjugate point is set to a predetermined distance from the reduction-side end face of the optical element PA, and the original image SA is installed at the reduction conjugate point.

The optical element PA has two transmitting surfaces that are flat and parallel with each other (surfaces 1, 2). The surface numbers will be referred to in the numerical examples to be described later. The lens element L1 has a biconvex shape (surfaces 3, 4). The lens element L2 has a negative meniscus shape, with a convex surface facing the reduction side (surfaces 5, 6). The lens element L3 has a biconvex shape (surfaces 7, 8). The lens element L4 has a negative meniscus shape, with a convex surface facing the reduction side (surfaces 9, 10). The lens element L5 has a biconvex shape (surfaces 11, 12). The lens element L6 has a negative meniscus shape, with a convex surface facing the reduction side (surfaces 13, 14). The lens element L7 has a biconvex shape (surfaces 16, 17). The lens element L8 has a positive meniscus shape, with a convex surface facing the reduction side (surfaces 18, 19). The lens element L9 has a negative meniscus shape, with a convex surface facing the magnification side (surfaces 20, 21). The lens element L10 has a biconcave shape (surfaces 22, 23). The lens element L11 has a negative meniscus shape, with a convex surface facing the magnification side (surfaces 24, 25). Each of these lens elements L1 to L11 is a rotationally symmetric lens the surfaces of which have shapes that are rotationally symmetric about the optical axis OA of the first sub-optical system, and the part where no light rays pass may be removed, as necessary.

The second sub-optical system includes a prism PM made of a transparent medium such as glass or synthetic resin. The prism PM has a plurality of optical surfaces. The plurality of optical surfaces include: on the light path of the light flux between the first sub-optical system and the magnification conjugate point, a first transmitting surface T1 located closest to the first sub-optical system, a second transmitting surface T2 located closest to the magnification conjugate point; and a first reflecting surface R1 and a second reflecting surface R2 located closest to the first transmitting surface T1 and to the second transmitting surface T2, respectively, on the light path between the first transmitting surface T1 and the second transmitting surface T2. The first transmitting surface T1 has a free-form surface, with a convex surface facing the magnification side (surface 26). The first reflecting surface R1 has a free-form surface, with a concave surface facing the direction in which the light ray of light being incident on the first reflecting surface R1 is reflected (surface 27). The second reflecting surface R2 has a free-form surface, with a convex surface facing the direction in which the light ray of light being incident on the second reflecting surface R2 is reflected (surface 28). The second transmitting surface T2 has a free-form surface, with a convex surface facing the magnification side (surface 29).

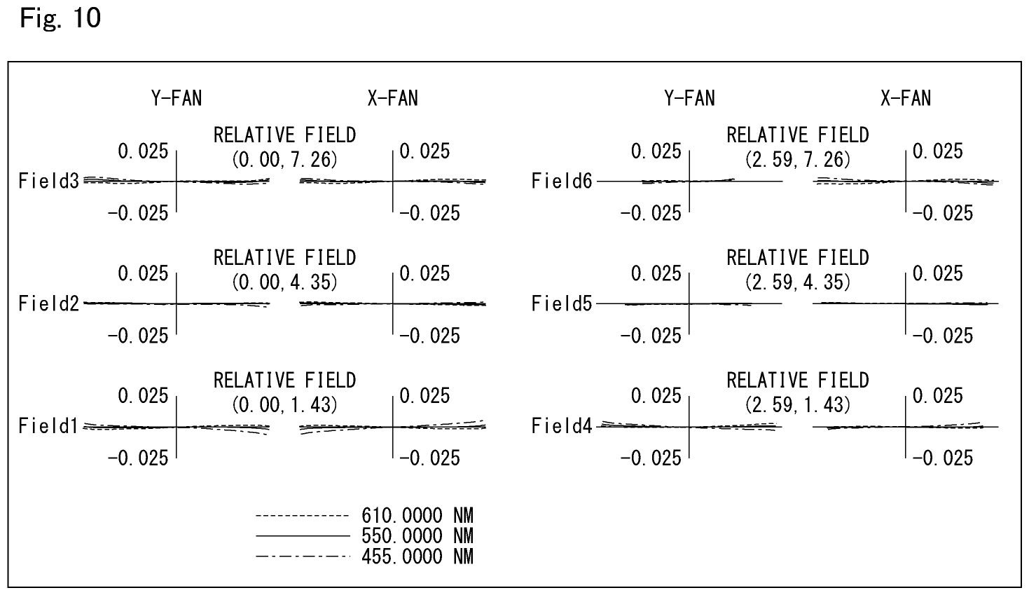

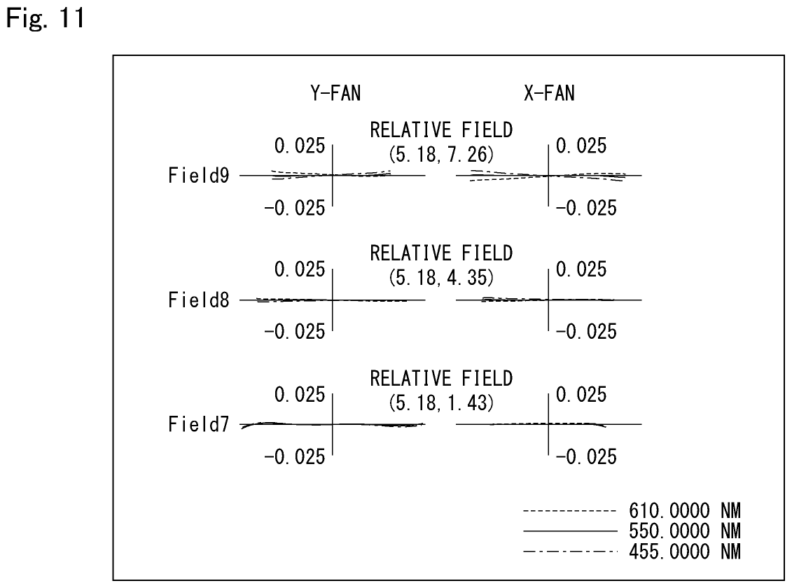

FIGS. 10 and 11 are plots of transverse aberrations in the optical system 1 according to second example. These plots correspond to the coordinates (X, Y)=(0.00,1.43), (0.00,4.35), (0.00,7.26), (2.59,1.43), (2.59,4.35), (2.59,7.26), (5.18,1.43), (5.18,4.35), and (5.18,7.26), respectively, inside a first rectangular effective area at the reduction conjugate point. From these plots, it can be seen that the optical system 1 according to second example exhibits excellent optical performance.

### Third Example

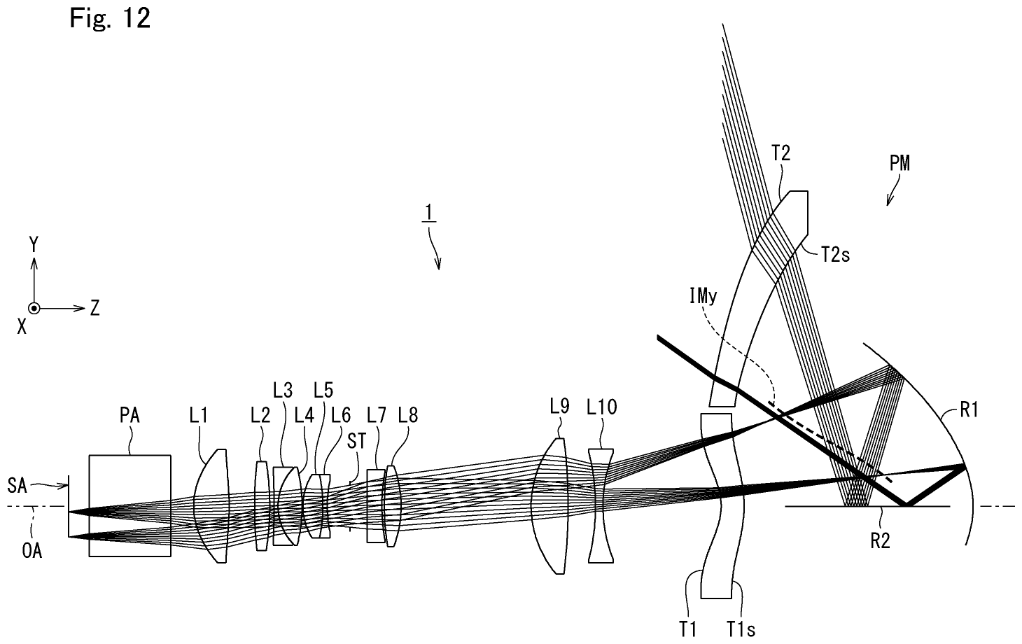

FIG. 12 is a diagram illustrating a layout of an optical system 1 according to third example. The optical system 1 has a configuration similar to that of first example, and redundant descriptions with first example will be omitted. The optical system 1 includes a first sub-optical system including a plurality of lens elements and an aperture stop ST, and a second sub-optical system including a plurality of optical surfaces. Note that the second sub-optical system according to third example is configured as a hollow prism PM having a cavity formed between the plurality of optical surfaces. In FIG. 12, the reduction conjugate point, which is the image-forming position on the reduction side, is located on the left side of the optical axis OA, and the magnification conjugate point, which is the image-forming position on the magnification side, is located on the upper left side of the optical axis OA. The second sub-optical system is provided on the magnification side of the first sub-optical system.

In addition, inside the optical system 1, there is an intermediate imaging position that is conjugate with each of the reduction conjugate point and the magnification conjugate point. This intermediate imaging position has both of a Y-direction intermediate image IMy and an X-direction intermediate image IMx, inside the second sub-optical system. The Y-direction intermediate image IMy is illustrated in FIG. 12, but the X-direction intermediate image IMx is not illustrated.

The first sub-optical system includes an optical element PA and lens elements L1 to L10 that are disposed sequentially from the reduction side to the magnification side. The reduction conjugate point is set to a predetermined distance from the reduction-side end face of the optical element PA, and the original image SA is installed at the reduction conjugate point.

The optical element PA has two transmitting surfaces that are flat and parallel with each other (surfaces 2, 3). The surface numbers will be referred to in the numerical examples to be described later. The lens element L1 has a biconvex shape (surfaces 4, 5). The lens element L2 has a biconvex shape (surfaces 6, 7). The lens element L3 has a biconcave shape (surfaces 8, 9). The lens element L4 has a biconvex shape (surfaces 9, 10). The lens elements L3, L4 are bonded to each other to form a compound lens. The lens element L5 has a biconvex shape (surfaces 11, 12). The lens element L6 has a biconcave shape (surfaces 12, 13). The lens elements L5, L6 are bonded to each other to form a compound lens. The lens element L7 has a biconcave shape (surfaces 15, 16). The lens element L8 has a biconvex shape (surfaces 17, 18). The lens element L9 has a biconvex shape (surfaces 19, 20). The lens element L10 has a biconcave shape (surfaces 21, 22). Each of these lens elements L1 to L10 is a rotationally symmetric lens the surfaces of which have shapes that are rotationally symmetric about the optical axis OA of the first sub-optical system, and the part where no light rays pass may be removed, as necessary.

The second sub-optical system includes, as a plurality of optical surfaces: on a light path of a light flux between the first sub-optical system and the magnification conjugate point, the first transmitting surface T1 located closest to the first sub-optical system; a first sub-transmitting surface T1s disposed nearby the first transmitting surface T1; the second transmitting surface T2 located closest to the magnification conjugate point; a second sub-transmitting surface T2s disposed nearby the second transmitting surface T2; the first reflecting surface R1 and the second reflecting surface R2 located closest to the first transmitting surface T1 and to the second transmitting surface T2, respectively, on the light path between the first transmitting surface T1 and the second transmitting surface T2. The first transmitting surface T1 has an aspherical surface, with a convex surface facing the magnification side (surface 23). The first sub-transmitting surface T1s is provided on the magnification side of the first transmitting surface T1, is an aspherical surface with a convex surface facing the magnification side (surface 24), and functions as a lens element together with the first transmitting surface T1. The first reflecting surface R1 has an odd-order aspherical surface, with a concave surface facing the direction in which the light ray of light being incident on the first reflecting surface R1 is reflected (surface 25). The second reflecting surface R2 is a spherical surface, with a convex surface facing the direction in which the light ray of light being incident on the second reflecting surface R2 is reflected (surface 26). The second transmitting surface T2 has an aspherical surface, with a convex surface facing the magnification side (surface 28). The second sub-transmitting surface T2s is provided on the reduction side of the second transmitting surface T2, has an aspherical surface with a convex surface facing the magnification side (surface 27), and functions as a lens element together with the second transmitting surface T2.

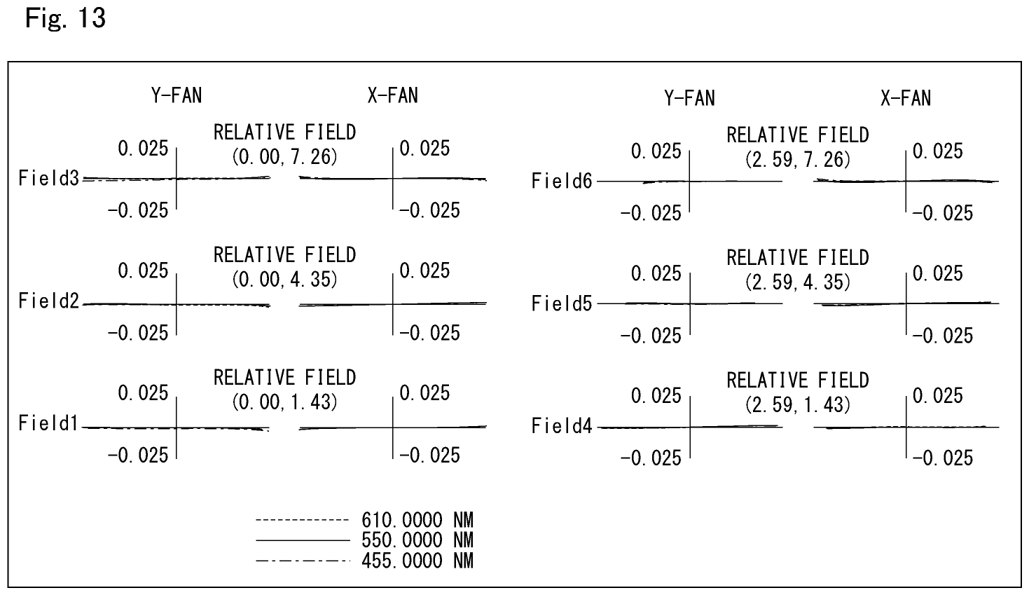

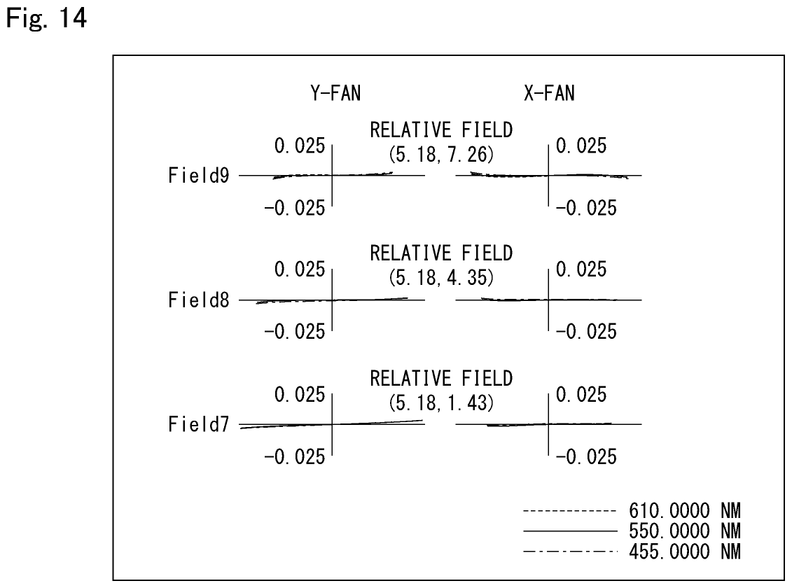

FIGS. 13 and 14 are plots of transverse aberration in the optical system 1 according to third example. These plots correspond to the coordinates (X, Y)=(0.00,1.43), (0.00,4.35), (0.00,7.26), (2.59,1.43), (2.59,4.35), (2.59,7.26), (5.18,1.43), (5.18,4.35), and (5.18,7.26), respectively, inside a first rectangular effective area at the reduction conjugate point. From these graphs, it can be seen that the optical system 1 according to third example exhibits excellent optical performance.

Next, conditions that can be satisfied by the optical system according to the embodiment will be described. Note that, although a plurality of conditions are defined for the optical system according to each of the examples, it is possible for the optical system to satisfy all of these plurality of conditions, or to achieve effects corresponding to individual conditions, by satisfying corresponding conditions.

An optical system according to the embodiment includes is an optical system having a reduction conjugate point on a reduction side and a magnification conjugate point on a magnification side, and having an intermediate imaging position conjugate with the reduction conjugate point and the magnification conjugate point inside, the optical system includes:
a first sub-optical system including a plurality of lenses that are rotationally symmetric with respect to an optical axis OA, and an aperture stop between two lenses among the plurality of lenses; and
a second sub-optical system disposed on the magnification side of the first sub-optical system and including a plurality of optical surfaces,
in a direction of the optical axis from the first sub-optical system to the second sub-optical system, a magnification conjugate plane including the magnification conjugate point is positioned in a direction of the first sub-optical system, from a viewpoint of the second sub-optical system, substantially perpendicularly to the optical axis OA, and
the plurality of optical surfaces include: on a light path of a light flux between the first sub-optical system and the magnification conjugate point,
   a first transmitting surface T1 located closest to the first sub-optical system;
   a second transmitting surface T2 located closest to the magnification conjugate point;
   a first reflecting surface R1 located closest to the first transmitting surface T1 on the light path between the first transmitting surface T1 and the second transmitting surface T2; and
   a second reflecting surface R2 located closest to the second transmitting surface T2 on the light path between the first transmitting surface T1 and the second transmitting surface T2,
a light path from the first transmitting surface to the first reflecting surface and a light path from the second reflecting surface to the second transmitting surface intersect with each other, and
a first effective area through which a light flux passes in the first transmitting surface T1 and a second effective area through which the light flux passes in the second transmitting surface T2 do not overlap each other.

As illustrated in FIG. 5A, the second sub-optical system (e.g., the prism PM) includes, as the optical surfaces, the first transmitting surface T1, the first reflecting surface R1, the second reflecting surface R2, and the second transmitting surface T2 that are disposed sequentially from the reduction side to the magnification side. Furthermore, for the ease of understanding, only the light flux closest to the optical axis OA and the principal ray PR thereof are illustrated, among the total light rays passing through or reflecting on the effective areas of the respective optical surfaces. In this case, the first effective area through which all of the light fluxes pass can be defined in the first transmitting surface T1, and the second effective area through which all of the light fluxes pass can also be defined in the second transmitting surface T2. The first effective area and the second effective area correspond to the reduction-side effective area through which all of the light fluxes pass, at the reduction conjugate point, and correspond to the magnification-side effective area through which all of the light fluxes pass, at the magnification conjugate point.

The optical system according to the embodiment is designed in such a manner that the first effective area and the second effective area do not overlap each other. As a result, the shape of each of the first transmitting surface T1 and the second transmitting surface T2 can be designed independently, so that the degree of freedom in the optical design is improved, and that individual optimizations are made possible. Therefore, it is advantageous in achieving a wider field of view, and, in the case of a projection device, for example, the throw ratio TR (projection distance/horizontal size of screen) can be reduced. The boundary between the first transmitting surface T1 and the second transmitting surface T2 may form an edge with an acute angle, and may be C-chamfered or R-chamfered, for example.

Furthermore, if the first effective area and the second effective area are overlapping each other, upon being subjected to a highly intense light flux, the overlapping area receives an increased amount of light, and is therefore affected more by the thermal effect due to the absorption loss, and a deformation due to thermal expansion becomes a concern, for example. As a countermeasure, by designing the first effective area and the second effective area not overlapping each other, these areas are thermally isolated from each other, so that the thermal effect can be alleviated.

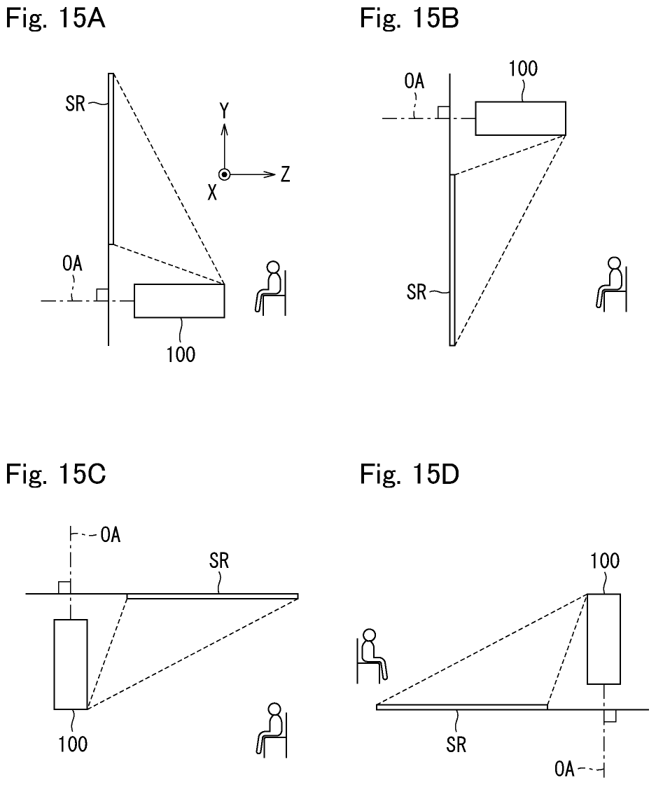

In addition, a magnification conjugate plane including the magnification conjugate point is positioned on the reduction side, from a viewpoint of the second sub-optical system, and is positioned substantially perpendicularly to the optical axis OA, for example. For example, with the optical system 1 mounted on the image projection apparatus 100, as illustrated in FIG. 15A, the image projection apparatus 100 is enabled for a diagonal upper-rearward projection that is a projection in which an image is projected from the second sub-optical system in the image projection apparatus 100 toward the screen SR (magnification conjugate plane) installed above, on the wall surface. In FIG. 15A, the first sub-optical system is positioned on the left side in the image projection apparatus 100; the second sub-optical system is positioned on the right side in the image projection apparatus 100; and the image light is projected from the second sub-optical system, which is in the right end of the image projection apparatus 100, toward the screen SR on the rear side. The screen SR is disposed substantially perpendicularly to the optical axis OA (the same is applied hereunder). Furthermore, as illustrated in FIG. 15B, the image projection apparatus 100 is enabled for a diagonal lower-rearward projection in which an image is projected from the second sub-optical system toward the screen SR installed below, on the wall surface. Furthermore, as illustrated in FIG. 15C, the image projection apparatus 100 is enabled for a diagonal upper-rearward projection in which an image is projected from the second sub-optical system toward the screen SR installed on the ceiling. Furthermore, as illustrated in FIG. 15D, the image projection apparatus 100 is enabled for a diagonal lower-rearward projection from the second sub-optical system toward the screen SR installed on the floor. In any of these cases, because the image projection apparatus 100 can be installed between the projecting position and the screen SR, the efficiency of space utilization is improved. Note that the magnification conjugate plane being positioned “substantially perpendicular” to the optical axis OA means that the magnification conjugate plane is positioned at an angle of 80 degrees or more and less than 100 degrees with respect to the optical axis OA.

In the optical system according to the embodiment, the principal ray PR of the light flux closest to the optical axis OA may be reflected by the second reflecting surface R2 at an angle θa of 30 degrees or more and less than 50 degrees with respect to the optical axis OA.

As illustrated in FIG. 6A, this angle θa formed by the direction in which principal ray PR of the light flux closest to optical axis OA is reflected on the second reflecting surface R2 can be defined with reference to the optical axis OA. Because the optical axis OA is near the second reflecting surface R2, an auxiliary line DA that is in parallel with the optical axis OA is additionally drawn, for the ease of understanding. In the optical system according to the embodiment, because the angle θa is 30 degrees or more, it is possible to prevent the principal ray PR reflected from the second reflecting surface R2 from passing through the first transmitting surface T1. Furthermore, because the angle θa is less than 50 degrees, it is possible to set the principal ray of the light flux farthest away from the optical axis OA to an angle less than 90 degrees in the case of the rearward projection, and to limit the second effective area of the second transmitting surface T2 to some extent.

In the optical system according to the embodiment, the first transmitting surface T1 and the second transmitting surface T2 may be defined by curvatures or free-form surface coefficients that are different from each other, respectively.

Representing a “free-form surface coefficient” in a local orthogonal coordinate system (x, y, z) having the origin at the vertex of the surface, the z coordinate (sag) can be defined using a curvature c at the vertex of the surface, a conic constant k, and a polynomial ΣCⱼx^{m}yⁿ, as mentioned below in [Math 2] and [Math 3]. In the optical system according to the embodiment, because the first transmitting surface T1 and the second transmitting surface T2 are defined by curvatures or free-form surface coefficients that are different from each other, respectively, the degree of freedom in the optical design is improved, and individual optimizations are made possible.

In the optical system according to the embodiment, when a light ray travels within a YZ plane (meridional plane) including the Z direction extending along the optical axis OA and the Y direction perpendicular to the Z direction, in the second sub-optical system, and
when a principal ray PR of a light flux closest to the optical axis OA passes through a first point of the second transmitting surface T2 on the YZ plane, the principal ray PR may travel outside the second sub-optical system in a direction closer to the first sub-optical system than a normal line of the second transmitting surface T2, the normal line passing through the first point of the second transmitting surface T2.

As illustrated in FIG. 6B, the principal ray PR of the light flux closest to optical axis OA is reflected on the first reflecting surface R1, is then reflected on the second reflecting surface R2, passes through the first point in the second transmitting surface T2, and emerges out from the second sub-optical system. At this time, when a positive angle is an angle on the side closer to the first sub-optical system with respect to the normal line Nb of the second transmitting surface T2, the normal line Nb passing through the first point, the principal ray PR travelling outside of the second sub-optical system preferably forms a positive angle θb, and more preferably, 5 degrees or more. In FIG. 6B, a positive angle is formed in the counterclockwise direction with respect to the normal line Nb. As a result, it is possible to output the principal ray PR at an angle more acute than that formed by the normal line Nb, so that the magnification conjugate point can be set to a lower position.

In the optical system according to the embodiment, the first transmitting surface T1 may have a concave surface, from a viewpoint of the first sub-optical system.

With such a configuration, each light ray passing through the first transmitting surface T1 diverges, so that it is possible to make the lens effective aperture stop of the first sub-optical system smaller, as well as to make the overall length of the optical system short.

In the optical system according to the embodiment, the second transmitting surface T2 may have a convex surface, from a viewpoint of the magnification conjugate point.

With such a configuration, each light ray passing through the second transmitting surface T2 converges, so that it is possible to make the lens effective aperture stop of the first sub-optical system smaller, as well as to make the overall length of the optical system short.

In the optical system according to the embodiment, the second reflecting surface R2 may have a convex surface, from a viewpoint of the second transmitting surface.

With such a configuration, each light ray reflected on the second reflecting surface R2 diverges, so that it is possible to keep the diameter of the light flux on the second reflecting surface R2 smaller, so that the light flux is less affected by the surface precision. If a flat surface is used for the second reflecting surface R2, as the manufacturing error and the diameter of the light flux increase, the more easily the second reflecting surface R2 is affected by the surface precision such as undulation.

In the optical system according to the embodiment, the first reflecting surface R1 may have a concave surface, from a viewpoint of the second transmitting surface. With such a configuration, the light ray reflected on the first reflecting surface R1 converges, so that it is possible to keep the size of the second sub-optical system small, as well as to make the overall length of the optical system short.

In the optical system according to the embodiment, at least one of the first transmitting surface T1, the second transmitting surface T2, the first reflecting surface R1, and the second reflecting surface R2 may have a free-form surface.

With such a configuration, not only the optical performance of the second sub-optical system can be improved, but also the size of the second sub-optical system can be reduced.

In the optical system according to the embodiment, the second sub-optical system may include a prism having the first transmitting surface, the second transmitting surface, the first reflecting surface, and the second reflecting surface.

With such a configuration, not only the optical performance of the second sub-optical system can be improved, but also the size of the second sub-optical system can be reduced.

In the optical system according to the embodiment, the prism PM may be made of a material having a refractive index of 1.5 or higher at a wavelength of 587.56 nm (d-line). Further, the prism PM may be made of a material having a refractive index of 1.6 or higher at a wavelength of 587.56 nm (d-line). By using a higher refractive index, the prism PM can be further reduced in size.

With such a configuration, because the optical power of the prism PM can be increased, it is advantageous for achieving a wider field of view, and in the case of a projection device, for example, the throw ratio TR can be reduced.

In the optical system according to the embodiment, the intermediate imaging position may be located inside the prism PM.

With such a configuration, it is possible to reduce the size of the prism PM, and to achieve a wider field of view to the optical system, in comparison with those of the optical system not having the intermediate imaging position.

In the optical system according to the embodiment, the magnification conjugate plane may be positioned at an angle of 80 degrees or more and less than 100 degrees with respect to the optical axis.

Numerical examples for the optical system according to first and second examples will now be explained. In each of the numerical examples, the units of lengths in the tables are all “mm”, and the units of the angle of view are all “degree”. Furthermore, in each of the numerical examples, a surface type (XY polynomial surface, spherical surface, aspherical surface), a curvature radius, a surface interval, a refractive index at the d-line, an Abbe number at the d-line, a material, refraction/reflection, an eccentricity type, a Y eccentricity, and a Z eccentricity, and a rotation amount are illustrated. These various amounts in the numerical examples are calculated on the basis of a wavelength of 550 nm. Furthermore, in each of the numerical examples, the shape of an aspherical surface is defined by the following mathematical formula. Note that, as the aspherical coefficients, only non-zero coefficients other than the conic constant k are listed.

$$z = \frac{{cr}^{3}}{1 + \sqrt{1 - ( 1 + k ) {c}^{2} {r}^{3}}} + {Ar}^{4} + {Br}^{6} + {Cr}^{8} + {Dr}^{10} + {Er}^{12} + {Fr}^{14} + {Gr}^{16} + {Hr}^{18} \qquad [ Math 1 ]$$

Here:
z is a sag height of a surface parallel to the z axis,
r is a distance in radial direction (=a square root of (x²+y²)),
c is curvature at surface vertex
k is a conic constant, and
A to H are 4th to 18th order aspherical coefficients of r.

The free-form surface shape is defined by the following mathematical formula using a local orthogonal coordinate system (x, y, z) having the origin at the vertex of the surface.

$$z = \frac{c {r}^{2}}{1 + \sqrt{1 - ( 1 + k ) {c}^{2} {r}^{2}}} + {\sum }_{j = 2}^{137} {C}_{j} {x}^{m} {y}^{n} \qquad [ Math 2 ]$$

$$j = \frac{{( m + n )}^{2} + m + 3 n}{2} + 1 \qquad [ Math 3 ]$$

Here:
z is a sag height of a surface parallel to the z axis,
r is a distance in radial direction (=a square root of (x²+y²)),
c is curvature at surface vertex,
k is a conic constant, and
Cⱼ is a coefficient of monomial x^{m}yⁿ.

In each piece of the following data, the i-th degree term of x and the j-th degree term of y, which are free-form surface coefficients in the polynomial, are described as x**i*y**j. For example, “X**2*y” indicates free-form surface coefficients of a quadratic term of x and a linear term of y in the polynomial.

### First Numerical Example

For the optical system in first numerical example (corresponding to first example), the lens data is indicated in Table 1, the data of the aspherical surface of the lens is indicated in Table 2, and the data of the free-form surface of the prism is indicated in Table 3. Note that “DAR (Decenter and Return)” in Table 1 means coordinate conversion between the global coordinates and the local coordinates, at the time of numerical calculation. The same applies to other numerical examples.

TABLE 1

| | | | | | | | | Eccen- | Y | Z | |
|---|---|---|---|---|---|---|---|---|---|---|---|
| | Surface | Surface | Curvature | | Refractive | Abbe | Refraction/ | tricity | Eccen- | Eccen- | α |
| | Number | Type | Radius | Interval | Index | Number | Reflection | Type | tricity | tricity | Rotation |
| SA | Object | | | 0.000 | | | | | | | |
| PA | 1 | Spherical | ∞ | 11.597 | 1.517 | 64.166 | Refraction | | | | |
| PA | 2 | Spherical | ∞ | 10.669 | 1.000 | 0.000 | Refraction | | | | |
| L1 | 3 | Spherical | 18.382 | 6.440 | 1.690 | 31.138 | Refraction | | | | |
| L1 | 4 | Spherical | −62.206 | 2.000 | 1.000 | 0.000 | Refraction | | | | |
| L2 | 5 | Asperical | −74.669 | 2.000 | 1.689 | 31.023 | Refraction | | | | |
| L2 | 6 | Asperical | 53.259 | 2.743 | 1.000 | 0.000 | Refraction | | | | |
| L3 | 7 | Spherical | 17.762 | 6.896 | 1.497 | 81.607 | Refraction | | | | |
| L3 | 8 | Spherical | −24.254 | 0.200 | 1.000 | 0.000 | Refraction | | | | |
| L4 | 9 | Spherical | 104.755 | 1.000 | 1.835 | 42.721 | Refraction | | | | |
| L4 | 10 | Spherical | 9.036 | 0.010 | 1.567 | 42.839 | Refraction | | | | |
| L5 | 11 | Spherical | 9.036 | 9.713 | 1.437 | 95.099 | Refraction | | | | |
| L5 | 12 | Spherical | −14.603 | 0.850 | 1.000 | 0.000 | Refraction | | | | |
| L6 | 13 | Asperical | 50.338 | 1.627 | 1.822 | 24.039 | Refraction | | | | |
| L6 | 14 | Asperical | 19.727 | 0.888 | 1.000 | 0.000 | Refraction | | | | |
| ST | 15 | Spherical | ∞ | 21.378 | 1.000 | 0.000 | Refraction | | | | |
| L7 | 16 | Spherical | 96.817 | 8.489 | 1.805 | 25.456 | Refraction | | | | |
| L7 | 17 | Spherical | −36.320 | 1.505 | 1.000 | 0.000 | Refraction | | | | |
| L8 | 18 | Spherical | 22.030 | 7.252 | 1.518 | 58.960 | Refraction | | | | |
| L8 | 19 | Spherical | 59.487 | 4.761 | 1.000 | 0.000 | Refraction | | | | |
| L9 | 20 | Spherical | −30.871 | 2.000 | 1.847 | 23.784 | Refraction | | | | |
| L9 | 21 | Spherical | 46.872 | 5.147 | 1.000 | 0.000 | Refraction | | | | |
| L10 | 22 | Asperical | −67.444 | 6.484 | 1.509 | 56.474 | Refraction | DAR | 0.159 | | |
| L10 | 23 | Asperical | 1613.259 | 10.036 | 1.000 | 0.000 | Refraction | DAR | 0.159 | | |
| T1 | 24 | XY Polynomial | −96.476 | 29.000 | 1.587 | 59.013 | Refraction | DAR | −0.317 | | |
| | | Surface | | | | | | | | | |
| R1 | 25 | XY Polynomial | −12.447 | −10.000 | 1.587 | 260.216 | Reflection | DAR | 0.328 | | |
| | | Surface | | | | | | | | | |
| R2 | 26 | XY Polynomial | 4229.205 | −24.683 | 1.587 | 59.013 | Reflection | DAR | 1.029 | 2.412 | −89.500 |
| | | Surface | | | | | | | | | |
| T2 | 27 | XY Polynomial | 26.818 | −4.036 | 1.000 | 0.000 | Refraction | DAR | 1.828 | | |
| | | Surface | | | | | | | | | |
| SR | 28 | | ∞ | −437.579 | 1.000 | 0.000 | Refraction | | | | |
| Image | | | | 0.000 | 1.000 | 0.000 | Refraction | | | | |

| | |
|---|---|
| Object Height | Image Height |

| Field | X | Y | X | Y | |
|---|---|---|---|---|---|
| f1 | 0.000 | −1.429 | 0.0 | 304.0 | |
| f2 | 0.000 | −4.345 | 0.0 | 925.5 | |
| f3 | 0.000 | −7.261 | 0.0 | 1548.4 | |
| f4 | 2.592 | −1.429 | 552.3 | 304.7 | |
| f5 | 2.592 | −4.345 | 554.2 | 923.6 | |
| f6 | 2.592 | −7.261 | 551.8 | 1547.9 | |
| f7 | 5.184 | −1.429 | 1105.0 | 302.9 | |
| f8 | 5.184 | −4.345 | 1106.9 | 926.9 | |
| f9 | 5.184 | −7.261 | 1104.1 | 1550.3 | |
| | | | 2213.7 | 1244.5 | 100.0 inch |

Aperture Diameter

| | |
|---|---|
| Aperture Stop Surface | 6.626 |

Display Element Size

| | |
|---|---|
| Long Side | 10.368 |
| Short Side | 5.832 |
| Display Element Shift Range | −4.345 |

TABLE 2
Aspherical Coefficient

| | S5 | S6 | S13 | S14 | S22 | S23 |
|---|---|---|---|---|---|---|
| Conic Constant (K) | 1.15091E+00 | 9.61680E−01 | −1.10414E+00 | −5.14832E+00 | 0.354498915 | 1.63840E−01 |
| Fourth Order Coefficient (A) | 9.60944E−06 | 1.35790E−04 | 6.75224E−06 | 5.92352E−05 | 5.87188E−05 | −7.71595E−05 |
| Sixth order coefficient (B) | −2.71903E−07 | 4.50291E−08 | 1.22425E−06 | 7.17733E−07 | −1.47217E−07 | −6.45753E−08 |
| Eighth Order Coefficient (C) | −1.64910E−09 | 6.01013E−10 | 1.57491E−08 | 1.89E−08 | 3.00966E−10 | 7.53E−10 |
| Tenth Order Coefficient (D) | 9.28812E−12 | −1.28503E−11 | −2.09972E−11 | 1.87060E−11 | −2.09238E−13 | −9.34E−13 |
| Twelfth Order Coefficient (E) | | | | | 5.86E−16 | −1.63E−16 |
| Fourteenth Order Coefficient (F) | | | | | −3.38E−18 | −2.04E−18 |

TABLE 3
XY Polynomial Surface Coefficient

| | Conic Constant (K) | | 8.07488 | | | |
|---|---|---|---|---|---|---|
| S24 | X**0 | X**1 | X**2 | X**3 | X**4 | X**5 |
| Y**0 | | 0.00000E+00 | −1.34921E−02 | 0.00000E+00 | 3.37338E−05 | 0.00000E+00 |
| Y**1 | −6.02131E−03 | 0.00000E+00 | −6.02467E−04 | 0.00000E+00 | 1.18684E−05 | 0.00000E+00 |
| Y**2 | −2.37134E−02 | 0.00000E+00 | 3.23223E−04 | 0.00000E+00 | −4.04122E−06 | 0.00000E+00 |
| Y**3 | 1.22184E−03 | 0.00000E+00 | −8.72309E−06 | 0.00000E+00 | 5.79077E−08 | 0.00000E+00 |
| Y**4 | 6.50081E−05 | 0.00000E+00 | −2.72422E−06 | 0.00000E+00 | 2.29885E−08 | 0.00000E+00 |
| Y**5 | −2.42996E−06 | 0.00000E+00 | −1.32074E−09 | 0.00000E+00 | −5.87239E−11 | 0.00000E+00 |
| Y**6 | −7.90856E−07 | 0.00000E+00 | 1.61311E−08 | 0.00000E+00 | −5.46052E−11 | |
| Y**7 | 4.23421E−10 | 0.00000E+00 | 9.42711E−12 | 0.00000E+00 | | |
| Y**8 | 3.67899E−09 | 0.00000E+00 | −2.90512E−11 | | | |
| Y**9 | −5.51684E−13 | 0.00000E+00 | | | | |
| Y**10 | −5.28653E−12 | | | | | |

| S24 | X**6 | X**7 | X**8 | X**9 | X**10 |
|---|---|---|---|---|---|
| Y**0 | −4.73482E−07 | 0.00000E+00 | 2.12172E−09 | 0.00000E+00 | −5.63142E−13 |
| Y**1 | −5.20506E−08 | 0.00000E+00 | 4.15414E−11 | 0.00000E+00 | |
| Y**2 | 1.83929E−08 | 0.00000E+00 | −3.00554E−11 | | |
| Y**3 | 3.51464E−11 | 0.00000E+00 | | | |
| Y**4 | −6.01924E−11 | | | | |
| Y**5 | | | | | |
| Y**6 | | | | | |
| Y**7 | | | | | |
| Y**8 | | | | | |
| Y**9 | | | | | |
| Y**10 | | | | | |

| | Conic Constant (K) | | −0.78568 | | | |
|---|---|---|---|---|---|---|
| S25 | X**0 | X**1 | X**2 | X**3 | X**4 | X**5 |
| Y**0 | | 0.00000E+00 | 6.04512E−03 | 0.00000E+00 | 3.76648E−05 | 0.00000E+00 |
| Y**1 | −2.52886E−02 | 0.00000E+00 | 3.55198E−05 | 0.00000E+00 | 5.42482E−08 | 0.00000E+00 |
| Y**2 | 7.06496E−03 | 0.00000E+00 | 6.24773E−05 | 0.00000E+00 | −9.84489E−08 | 0.00000E+00 |
| Y**3 | −3.25070E−05 | 0.00000E+00 | 1.12287E−06 | 0.00000E+00 | 6.76221E−11 | 0.00000E+00 |
| Y**4 | 3.72263E−05 | 0.00000E+00 | −1.30352E−07 | 0.00000E+00 | 3.62161E−10 | 0.00000E+00 |
| Y**5 | −2.01903E−07 | 0.00000E+00 | 7.30694E−10 | 0.00000E+00 | −1.17805E−14 | 0.00000E+00 |
| Y**6 | −1.99089E−08 | 0.00000E+00 | 2.44103E−10 | 0.00000E+00 | −3.39385E−14 | |
| Y**7 | 4.90386E−11 | 0.00000E+00 | −8.10308E−13 | 0.00000E+00 | | |
| Y**8 | 5.73358E−11 | 0.00000E+00 | 6.62151E−15 | | | |
| Y**9 | 5.91784E−14 | 0.00000E+00 | | | | |
| Y**10 | −7.03293E−15 | | | | | |

| S25 | X**6 | X**7 | X**8 | X**9 | X**10 |
|---|---|---|---|---|---|
| Y**0 | −2.89066E−08 | 0.00000E+00 | 5.22728E−11 | 0.00000E+00 | −1.43129E−15 |
| Y**1 | 4.63002E−10 | 0.00000E+00 | −4.39420E−13 | 0.00000E+00 | |
| Y**2 | 2.40264E−10 | 0.00000E+00 | −1.21726E−13 | | |
| Y**3 | 1.75235E−12 | 0.00000E+00 | | | |
| Y**4 | −9.97337E−14 | | | | |
| Y**5 | | | | | |
| Y**6 | | | | | |
| Y**7 | | | | | |
| Y**8 | | | | | |
| Y**9 | | | | | |
| Y**10 | | | | | |

| | Conic Constant (K) | | 0.96233 | | | |
|---|---|---|---|---|---|---|
| S26 | X**0 | X**1 | X**2 | X**3 | X**4 | X**5 |
| Y**0 | | 0.00000E+00 | −2.24868E−03 | 0.00000E+00 | 1.59671E−04 | 0.00000E+00 |
| Y**1 | 2.19387E−03 | 0.00000E+00 | −8.38480E−04 | 0.00000E+00 | 6.49423E−05 | 0.00000E+00 |
| Y**2 | 5.22240E−04 | 0.00000E+00 | −1.10806E−04 | 0.00000E+00 | 9.01268E−06 | 0.00000E+00 |
| Y**3 | −2.03765E−05 | 0.00000E+00 | −9.91240E−06 | 0.00000E+00 | 9.16415E−08 | 0.00000E+00 |
| Y**4 | 2.44103E−06 | 0.00000E+00 | −6.51861E−07 | 0.00000E+00 | −7.94248E−08 | 0.00000E+00 |
| Y**5 | 5.40923E−07 | 0.00000E+00 | −8.50358E−08 | 0.00000E+00 | −4.89328E−09 | 0.00000E+00 |
| Y**6 | −2.83907E−08 | 0.00000E+00 | −2.12767E−09 | 0.00000E+00 | −3.79475E−11 | |
| Y**7 | −1.20980E−09 | 0.00000E+00 | 1.19775E−09 | 0.00000E+00 | | |
| Y**8 | 2.59764E−10 | 0.00000E+00 | 8.06742E−11 | | | |
| Y**9 | 5.93278E−12 | 0.00000E+00 | | | | |
| Y**10 | −4.60356E−13 | | | | | |

| S26 | X**6 | X**7 | X**8 | X**9 | X**10 |
|---|---|---|---|---|---|
| Y**0 | −6.55338E−06 | 0.00000E+00 | 1.05190E−07 | 0.00000E+00 | −3.00000E−10 |
| Y**1 | −2.57690E−06 | 0.00000E+00 | 3.39321E−08 | 0.00000E+00 | |
| Y**2 | −3.22798E−07 | 0.00000E+00 | 3.47416E−09 | | |
| Y**3 | −5.35148E−09 | 0.00000E+00 | | | |
| Y**4 | 6.53696E−10 | | | | |
| Y**5 | | | | | |
| Y**6 | | | | | |
| Y**7 | | | | | |
| Y**8 | | | | | |
| Y**9 | | | | | |
| Y**10 | | | | | |

| | Conic Constant (K) | | 0.00000 | | | |
|---|---|---|---|---|---|---|
| S27 | X**0 | X**1 | X**2 | X**3 | X**4 | X**5 |
| Y**0 | | 0.00000E+00 | −2.86368E−02 | 0.00000E+00 | 8.85124E−05 | 0.00000E+00 |
| Y**1 | −4.52540E−01 | 0.00000E+00 | 1.79213E−03 | 0.00000E+00 | −7.67526E−07 | 0.00000E+00 |
| Y**2 | 6.61708E−03 | 0.00000E+00 | 8.63821E−05 | 0.00000E+00 | −5.18371E−07 | 0.00000E+00 |
| Y**3 | 2.77115E−04 | 0.00000E+00 | 1.26189E−07 | 0.00000E+00 | −2.63626E−09 | 0.00000E+00 |
| Y**4 | 3.65242E−05 | 0.00000E+00 | −5.08396E−07 | 0.00000E+00 | 1.24973E−09 | 0.00000E+00 |
| Y**5 | 3.25783E−07 | 0.00000E+00 | −1.47369E−09 | 0.00000E+00 | 3.62162E−12 | 0.00000E+00 |
| Y**6 | −1.57839E−07 | 0.00000E+00 | 8.82862E−10 | 0.00000E+00 | −9.91473E−13 | |
| Y**7 | −2.47169E−10 | 0.00000E+00 | −2.98452E−12 | 0.00000E+00 | | |
| Y**8 | 2.16377E−10 | 0.00000E+00 | −4.04909E−13 | | | |
| Y**9 | −1.62610E−12 | 0.00000E+00 | | | | |
| Y**10 | −5.87954E−14 | | | | | |

| S27 | X**6 | X**7 | X**8 | X**9 | X**10 |
|---|---|---|---|---|---|
| Y**0 | −1.49611E−07 | 0.00000E+00 | 1.41381E−10 | 0.00000E+00 | −6.41287E−14 |
| Y**1 | −3.28814E−09 | 0.00000E+00 | 3.31155E−12 | 0.00000E+00 | |
| Y**2 | 8.34391E−10 | 0.00000E+00 | −4.91943E−13 | | |
| Y**3 | 5.83570E−12 | 0.00000E+00 | | | |
| Y**4 | −1.05030E−12 | | | | |
| Y**5 | | | | | |
| Y**6 | | | | | |
| Y**7 | | | | | |
| Y**8 | | | | | |
| Y**9 | | | | | |
| Y**10 | | | | | |

### Second Numerical Example

For the optical system in second numerical example (corresponding to second example), the lens data is indicated in Table 4, the data of the aspherical surface of the lens is indicated in Table 5, and the data of the free-form surface of the prism is indicated in Table 6.

TABLE 4

| | | | | | | | | Eccen- | Y | Z | |
|---|---|---|---|---|---|---|---|---|---|---|---|
| | Surface | Surface | Curvature | | Refractive | Abbe | Refraction/ | tricity | Eccen- | Eccen- | α |
| | Number | Type | Radius | Interval | Index | Number | Reflection | Type | tricity | tricity | Rotation |
| SA | Object | | | 0.000 | | | | | | | |
| PA | 1 | Spherical | ∞ | 11.597 | 1.517 | 64.166 | Refraction | | | | |
| PA | 2 | Spherical | ∞ | 10.668 | 1.000 | 0.000 | Refraction | | | | |
| L1 | 3 | Spherical | 16.605 | 6.308 | 1.690 | 31.138 | Refraction | | | | |
| L1 | 4 | Spherical | −132.601 | 1.372 | 1.000 | 0.000 | Refraction | | | | |
| L2 | 5 | Aspherical | 46.272 | 1.801 | 1.689 | 31.023 | Refraction | | | | |
| L2 | 6 | Aspherical | 20.650 | 1.220 | 1.000 | 0.000 | Refraction | | | | |
| L3 | 7 | Spherical | 13.790 | 6.069 | 1.497 | 81.607 | Refraction | | | | |
| L3 | 8 | Spherical | −27.154 | 0.200 | 1.000 | 0.000 | Refraction | | | | |
| L4 | 9 | Spherical | 68.929 | 1.000 | 1.835 | 42.721 | Refraction | | | | |
| L4 | 10 | Spherical | 8.108 | 0.010 | 1.567 | 42.839 | Refraction | | | | |
| L5 | 11 | Spherical | 8.108 | 8.231 | 1.437 | 95.099 | Refraction | | | | |
| L5 | 12 | Spherical | −13.795 | 0.200 | 1.000 | 0.000 | Refraction | | | | |
| L6 | 13 | Aspherical | 163.300 | 1.762 | 1.822 | 24.039 | Refraction | | | | |
| L6 | 14 | Aspherical | 20.184 | 1.844 | 1.000 | 0.000 | Refraction | | | | |
| ST | 15 | Spherical | ∞ | 16.926 | 1.000 | 0.000 | Refraction | | | | |
| L7 | 16 | Spherical | 79.219 | 9.761 | 1.808 | 22.764 | Refraction | | | | |
| L7 | 17 | Spherical | −36.558 | 3.183 | 1.000 | 0.000 | Refraction | | | | |
| L8 | 18 | Spherical | 24.229 | 6.467 | 1.554 | 71.760 | Refraction | | | | |
| L8 | 19 | Spherical | 367.909 | 2.452 | 1.000 | 0.000 | Refraction | | | | |
| L9 | 20 | Spherical | −45.478 | 1.801 | 1.923 | 20.880 | Refraction | | | | |
| L9 | 21 | Spherical | −98.156 | 3.144 | 1.000 | 0.000 | Refraction | | | | |
| L10 | 22 | Spherical | −31.050 | 1.818 | 1.847 | 23.784 | Refraction | | | | |
| L10 | 23 | Spherical | 64.036 | 3.709 | 1.000 | 0.000 | Refraction | | | | |
| L11 | 24 | Aspherical | −38.689 | 7.864 | 1.509 | 56.474 | Refraction | DAR | −0.038 | | |
| L11 | 25 | Aspherical | −190.792 | 10.040 | 1.000 | 0.000 | Refraction | DAR | −0.038 | | |
| T1 | 26 | XY Polynomial | −46.980 | 28.000 | 1.694 | 53.114 | Refraction | DAR | 0.527 | | |
| | | Surface | | | | | | | | | |
| R1 | 27 | XY Polynomial | −13.410 | −10.000 | 1.694 | 206.215 | Reflection | DAR | 1.348 | | |
| | | Surface | | | | | | | | | |
| R2 | 28 | XY Polynomial | 4234.836 | −28.067 | 1.694 | 53.114 | Reflection | DAR | −0.123 | −5.022 | −89.500 |
| | | Surface | | | | | | | | | |
| T2 | 29 | XY Polynomial | 24.598 | −1.740 | 1.000 | 0.000 | Refraction | DAR | −0.013 | | |
| | | Surface | | | | | | | | | |
| SR | 30 | | ∞ | −357.605 | 1.000 | 0.000 | Refraction | | | | |
| Image | | | | 0.000 | 1.000 | 0.000 | Refraction | | | | |

| | |
|---|---|
| Object Height | Image Height |

| Field | X | Y | X | Y | |
|---|---|---|---|---|---|
| f1 | 0.000 | −1.429 | 0.0 | 304.0 | |
| f2 | 0.000 | −4.345 | 0.0 | 925.5 | |
| f3 | 0.000 | −7.261 | 0.0 | 1548.4 | |
| f4 | 2.592 | −1.429 | 552.3 | 304.7 | |
| f5 | 2.592 | −4.345 | 554.2 | 923.6 | |
| f6 | 2.592 | −7.261 | 551.8 | 1547.9 | |
| f7 | 5.184 | −1.429 | 1105.0 | 302.9 | |
| f8 | 5.184 | −4.345 | 1106.9 | 926.9 | |
| f9 | 5.184 | −7.261 | 1104.1 | 1550.3 | |
| | | | 2213.7 | 1244.5 | 100.0 inch |

Aperture Diameter

| | |
|---|---|
| Aperture Stop Surface | 5.794 |

Display Element Size

| | |
|---|---|
| Long Side | 10.368 |
| Short Side | 5.382 |
| Display Element Shift Range | −4.345 |

TABLE 5
Aspherical Coefficient

| | S5 | S6 | S13 | S14 | S24 | S25 |
|---|---|---|---|---|---|---|
| Conic Constant (K) | −3.3707E+00 | 8.0743E−02 | 1.2079E+00 | −2.6650E+00 | 0.0000E+00 | 0.0000E+00 |
| Fourth Order Coefficient (A) | −7.8659E−05 | 7.7149E−05 | 1.6548E−04 | 1.6599E−04 | 7.9043E−05 | −7.7719E−05 |
| Sixth Order Coefficient (B) | −2.4916E−07 | 2.9013E−07 | 4.7034E−07 | 6.3014E−07 | −1.2945E−07 | 4.0115E−08 |
| Eighth Order Coefficient (C) | −2.6203E−10 | 3.4093E−09 | 1.3308E−08 | −2.9888E−08 | 1.8278E−10 | 3.2151E−10 |
| Tenth Order Coefficient (D) | 9.1953E−12 | −2.0596E−11 | | | −2.4777E−13 | −6.1848E−13 |
| Twelfth Order Coefficient (E) | | | | | | |
| Fourteenth Order Coefficient (F) | | | | | | |

TABLE 6
XY Polynomial Surface Coefficient

| | Conic Constant (K) | | 0.47683 | | | |
|---|---|---|---|---|---|---|
| S26 | X**0 | X**1 | X**2 | X**3 | X**4 | X**5 |
| Y**0 | | 0.00000E+00 | −9.51826E−03 | 0.00000E+00 | 7.02060E−05 | 0.00000E+00 |
| Y**1 | −1.90610E−02 | 0.00000E+00 | 1.81132E−04 | 0.00000E+00 | 4.41671E−07 | 0.00000E+00 |
| Y**2 | −4.40958E−03 | 0.00000E+00 | 8.86919E−05 | 0.00000E+00 | −1.16691E−06 | 0.00000E+00 |
| Y**3 | −2.80877E−04 | 0.00000E+00 | 5.93742E−06 | 0.00000E+00 | 2.08686E−08 | 0.00000E+00 |
| Y**4 | 7.16862E−05 | 0.00000E+00 | −1.20589E−06 | 0.00000E+00 | 7.94258E−09 | 0.00000E+00 |
| Y**5 | 3.42979E−07 | 0.00000E+00 | −5.12083E−09 | 0.00000E+00 | −2.06869E−10 | 0.00000E+00 |
| Y**6 | −3.50283E−07 | 0.00000E+00 | 5.70343E−09 | 0.00000E+00 | −1.26161E−11 | |
| Y**7 | 2.96041E−09 | 0.00000E+00 | −4.57421E−11 | 0.00000E+00 | | |
| Y**8 | 1.35123E−09 | 0.00000E+00 | −8.95519E−12 | | | |
| Y**9 | −2.75126E−11 | 0.00000E+00 | | | | |
| Y**10 | −1.28427E−12 | | | | | |

| S26 | X**6 | X**7 | X**8 | X**9 | X**10 |
|---|---|---|---|---|---|
| Y**0 | −3.73923E−07 | 0.00000E+00 | 1.52749E−09 | 0.00000E+00 | −2.22373E−12 |
| Y**1 | 1.98290E−08 | 0.00000E+00 | −1.19614E−10 | 0.00000E+00 | |
| Y**2 | 4.33541E−09 | 0.00000E+00 | −2.17003E−12 | | |
| Y**3 | −1.55529E−10 | 0.00000E+00 | | | |
| Y**4 | −1.16200E−11 | | | | |
| Y**5 | | | | | |
| Y**6 | | | | | |
| Y**7 | | | | | |
| Y**8 | | | | | |
| Y**9 | | | | | |
| Y**10 | | | | | |

| | Conic Constant (K) | | −0.85121 | | | |
|---|---|---|---|---|---|---|
| S27 | X**0 | X**1 | X**2 | X**3 | X**4 | X**5 |
| Y**0 | | 0.00000E+00 | −7.14128E−04 | 0.00000E+00 | 3.67874E−05 | 0.00000E+00 |
| Y**1 | −1.19836E−01 | 0.00000E+00 | 2.66273E−04 | 0.00000E+00 | −2.85180E−07 | 0.00000E+00 |
| Y**2 | 3.66019E−03 | 0.00000E+00 | 4.96350E−05 | 0.00000E+00 | −1.29675E−07 | 0.00000E+00 |
| Y**3 | −2.35533E−04 | 0.00000E+00 | 4.76859E−07 | 0.00000E+00 | 1.09408E−09 | 0.00000E+00 |
| Y**4 | 5.16691E−05 | 0.00000E+00 | −1.31083E−07 | 0.00000E+00 | 5.97324E−10 | 0.00000E+00 |
| Y**5 | −3.19251E−07 | 0.00000E+00 | 7.33784E−10 | 0.00000E+00 | −1.93352E−11 | 0.00000E+00 |
| Y**6 | −6.91424E−08 | 0.00000E+00 | 4.68680E−10 | 0.00000E+00 | 1.29554E−13 | |
| Y**7 | 4.59497E−10 | 0.00000E+00 | −1.07968E−11 | 0.00000E+00 | | |
| Y**8 | 1.56515E−10 | 0.00000E+00 | −7.05911E−14 | | | |
| Y**9 | −6.34994E−13 | 0.00000E+00 | | | | |
| Y**10 | −1.15397E−13 | | | | | |

| S27 | X**6 | X**7 | X**8 | X**9 | X**10 |
|---|---|---|---|---|---|
| Y**0 | −5.49088E−08 | 0.00000E+00 | 1.35152E−10 | 0.00000E+00 | −1.38064E−13 |
| Y**1 | −2.42850E−09 | 0.00000E+00 | 5.48371E−12 | 0.00000E+00 | |
| Y**2 | 7.39018E−10 | 0.00000E+00 | −9.44692E−13 | | |
| Y**3 | −1.11608E−11 | 0.00000E+00 | | | |
| Y**4 | −2.95958E−13 | | | | |
| Y**5 | | | | | |
| Y**6 | | | | | |
| Y**7 | | | | | |
| Y**8 | | | | | |
| Y**9 | | | | | |
| Y**10 | | | | | |

| | Conic Constant (K) | | 0.62888 | | | |
|---|---|---|---|---|---|---|
| S28 | X**0 | X**1 | X**2 | X**3 | X**4 | X**5 |
| Y**0 | | 0.00000E+00 | −6.71607E−05 | 0.00000E+00 | −1.19627E−04 | 0.00000E+00 |
| Y**1 | 1.28619E−02 | 0.00000E+00 | −1.74647E−04 | 0.00000E+00 | 3.97736E−05 | 0.00000E+00 |
| Y**2 | −2.11001E−04 | 0.00000E+00 | −2.19961E−06 | 0.00000E+00 | −4.82082E−06 | 0.00000E+00 |
| Y**3 | 2.34577E−05 | 0.00000E+00 | 1.08330E−05 | 0.00000E+00 | 0.00000E+00 | 0.00000E+00 |
| Y**4 | 3.79446E−06 | 0.00000E+00 | 1.33859E−06 | 0.00000E+00 | 0.00000E+00 | 0.00000E+00 |
| Y**5 | −5.52821E−07 | 0.00000E+00 | −1.46241E−06 | 0.00000E+00 | 0.00000E+00 | 0.00000E+00 |
| Y**6 | 2.10196E−07 | 0.00000E+00 | 2.23553E−07 | 0.00000E+00 | 0.00000E+00 | |
| Y**7 | −6.19893E−08 | 0.00000E+00 | 0.00000E+00 | 0.00000E+00 | | |
| Y**8 | 8.72615E−09 | 0.00000E+00 | 0.00000E+00 | | | |
| Y**9 | −4.08943E−10 | 0.00000E+00 | | | | |
| Y**10 | 4.34165E−12 | | | | | |

| S28 | X**6 | X**7 | X**8 | X**9 | X**10 |
|---|---|---|---|---|---|
| Y**0 | 9.60868E−06 | 0.00000E+00 | 0.00000E+00 | 0.00000E+00 | 0.00000E+00 |
| Y**1 | 0.00000E+00 | 0.00000E+00 | 0.00000E+00 | 0.00000E+00 | |
| Y**2 | 0.00000E+00 | 0.00000E+00 | 0.00000E+00 | | |
| Y**3 | 0.00000E+00 | 0.00000E+00 | | | |
| Y**4 | 0.00000E+00 | | | | |
| Y**5 | | | | | |
| Y**6 | | | | | |
| Y**7 | | | | | |
| Y**8 | | | | | |
| Y**9 | | | | | |
| Y**10 | | | | | |

| | Conic Constant (K) | | 0.00000 | | | |
|---|---|---|---|---|---|---|
| S29 | X**0 | X**1 | X**2 | X**3 | X**4 | X**5 |
| Y**0 | | 0.00000E+00 | −4.96448E−03 | 0.00000E+00 | 4.69059E−05 | 0.00000E+00 |
| Y**1 | −8.29155E−02 | 0.00000E+00 | 2.94433E−04 | 0.00000E+00 | 1.01720E−07 | 0.00000E+00 |
| Y**2 | 1.79894E−03 | 0.00000E+00 | 7.83662E−05 | 0.00000E+00 | −4.92356E−07 | 0.00000E+00 |
| Y**3 | 6.90317E−05 | 0.00000E+00 | 2.82074E−07 | 0.00000E+00 | −1.10442E−09 | 0.00000E+00 |
| Y**4 | 3.59817E−05 | 0.00000E+00 | −4.82859E−07 | 0.00000E+00 | 1.48652E−09 | 0.00000E+00 |
| Y**5 | 4.89804E−08 | 0.00000E+00 | −1.03706E−09 | 0.00000E+00 | −6.12032E−13 | 0.00000E+00 |
| Y**6 | −1.56035E−07 | 0.00000E+00 | 9.93444E−10 | 0.00000E+00 | −1.32169E−12 | |
| Y**7 | −1.65823E−10 | 0.00000E+00 | −1.83274E−13 | 0.00000E+00 | | |
| Y**8 | 2.47568E−10 | 0.00000E+00 | −6.72924E−13 | | | |
| Y**9 | −9.31767E−14 | 0.00000E+00 | | | | |
| Y**10 | −1.37185E−13 | | | | | |

| S29 | X**6 | X**7 | X**8 | X**9 | X**10 |
|---|---|---|---|---|---|
| Y**0 | −1.50624E−07 | 0.00000E+00 | 2.10630E−10 | 0.00000E+00 | −1.11624E−13 |
| Y**1 | −5.32961E−10 | 0.00000E+00 | −7.16663E−14 | 0.00000E+00 | |
| Y**2 | 9.42684E−10 | 0.00000E+00 | −6.05598E−13 | | |
| Y**3 | 2.58077E−13 | 0.00000E+00 | | | |
| Y**4 | −1.30299E−12 | | | | |
| Y**5 | | | | | |
| Y**6 | | | | | |
| Y**7 | | | | | |
| Y**8 | | | | | |
| Y**9 | | | | | |
| Y**10 | | | | | |

### Third Numerical Example

For the optical system in third numerical example (corresponding to third example), the lens data is indicated in Table 7, the data of the aspherical surface of the lens is indicated in Table 8, and the data of the odd-order aspherical surface of the prism is indicated in Table 9.

TABLE 7

| | | | | | | | | Eccen- | Y | Z | |
|---|---|---|---|---|---|---|---|---|---|---|---|
| | Surface | Surface | Curvature | | Refractive | Abbe | Refraction/ | tricity | Eccen- | Eccen- | α |
| | Number | Type | Radius | Interval | Index | Number | Reflection | Type | tricity | tricity | Rotation |
| SA | Object | Spherical | ∞ | 0.0000 | | | | | | | |
| | 1 | Spherical | ∞ | 5.0000 | 1.0000 | 0.000 | Refraction | | | | |
| PA | 2 | Spherical | ∞ | 19.5600 | 1.7432 | 49.340 | Refraction | | | | |
| PA | 3 | Spherical | ∞ | 5.5000 | 1.0000 | 0.000 | Refraction | | | | |
| L1 | 4 | Aspherical | 16.5890 | 8.4634 | 1.4970 | 81.609 | Refraction | | | | |
| L1 | 5 | Aspherical | −71.8835 | 6.1070 | 1.0000 | 0.000 | Refraction | | | | |
| L2 | 6 | Spherical | 99.8415 | 3.6438 | 1.7292 | 54.672 | Refraction | | | | |
| L2 | 7 | Spherical | −64.6741 | 1.0000 | 1.0000 | 0.000 | Refraction | | | | |
| L3 | 8 | Spherical | −175.6088 | 1.0000 | 2.0010 | 29.134 | Refraction | | | | |
| L4 | 9 | Spherical | 13.0331 | 5.7094 | 1.5168 | 64.199 | Refraction | | | | |
| L4 | 10 | Spherical | −38.6595 | 0.2000 | 1.0000 | 0.000 | Refraction | | | | |
| L5 | 11 | Spherical | 14.1004 | 4.8724 | 1.4875 | 70.436 | Refraction | | | | |
| L6 | 12 | Spherical | −33.2315 | 1.0000 | 2.0010 | 29.134 | Refraction | | | | |
| L6 | 13 | Spherical | 28.0071 | 5.4658 | 1.0000 | 0.000 | Refraction | | | | |
| ST Stop | 14 | Spherical | ∞ | 4.1151 | 1.0000 | 0.000 | Refraction | | | | |
| L7 | 15 | Spherical | −1264.7932 | 3.5000 | 1.7859 | 44.200 | Refraction | | | | |
| L7 | 16 | Spherical | 46.0016 | 0.5720 | 1.0000 | 0.000 | Refraction | | | | |
| L8 | 17 | Spherical | 55.0954 | 4.0611 | 1.8467 | 23.785 | Refraction | | | | |
| L8 | 18 | Spherical | −27.9737 | 31.2022 | 1.0000 | 0.000 | Refraction | | | | |
| L9 | 19 | Spherical | 25.2490 | 8.8000 | 1.5673 | 42.842 | Refraction | | | | |
| L9 | 20 | Spherical | −131.8344 | 6.6053 | 1.0000 | 0.000 | Refraction | | | | |
| L10 | 21 | Spherical | −52.5444 | 1.7982 | 1.9459 | 17.984 | Refraction | | | | |
| L10 | 22 | Spherical | 35.0766 | 28.2893 | 1.0000 | 0.000 | Refraction | | | | |
| T1 | 23 | Aspherical | −13.7028 | 5.5000 | 1.5094 | 56.470 | Refraction | | | | |
| T1s | 24 | Aspherical | −29.7818 | 54.9009 | 1.0000 | 0.000 | Refraction | | | | |
| R1 | 25 | Odd-Order | −22.0368 | −39.7708 | 1.0000 | 0.000 | Reflection | | | | |
| | | Aspherical | | | | | | | | | |
| R2 | 26 | Spherical | 9000.0000 | −20.0000 | 1.0000 | 0.000 | Reflection | DAR | 0.000 | 0 | −90 |
| T2s | 27 | Aspherical | 127.1928 | −5.9290 | 1.5094 | 56.470 | Refraction | | | | |
| T2 | 28 | Aspherical | 106.5433 | 0.0000 | 1.0000 | 0.000 | Refraction | | | | |
| SR | Image | Spherical | ∞ | −511.5955 | 1.0000 | 0.000 | Refraction | | | | |

| | |
|---|---|
| Object Height | Image Height |

| Field | X | Y | X | Y |
|---|---|---|---|---|
| f1 | 0.000 | −1.458 | 0.0 | 404.7 |
| f2 | 0.000 | −4.374 | 0.0 | 1214.1 |
| f3 | 0.000 | −7.290 | 0.0 | 2023.6 |
| f4 | 2.592 | −1.458 | 719.5 | 404.7 |
| f5 | 2.592 | −4.374 | 719.5 | 1214.1 |
| f6 | 2.592 | −7.290 | 719.5 | 2023.6 |
| f7 | 5.184 | −1.458 | 1439.0 | 404.7 |
| f8 | 5.184 | −4.374 | 1439.0 | 12.14.1 |
| f9 | 5.184 | −7.290 | 1439.0 | 2023.6 |

Aperture Diameter

| | |
|---|---|
| Aperture Stop Surface | 10.072 |

Display Element Size

| | |
|---|---|
| Long Side | 10.368 |
| Short Size | 5.832 |
| Element Size | 0.468 |
| Display Element Shift Amount | 4.374 |

Screen Projection Size

| | |
|---|---|
| 130 inch | 3302.0 |
| Long Side | 2877.9 |
| Short Side | 1618.8 |
| Imaging Magnification | 277.6 |

TABLE 8
Aspherical Coefficient

| | S4 | S5 | S23 | S24 | S27 | S28 |
|---|---|---|---|---|---|---|
| Conic Constant (K) | −0.89970 | −3.44997 | −2.60276 | −1.39500 | −3.72171 | −6.50415 |
| Fourth order coefficient (A) | −4.72596E−06 | 1.42243E−05 | 3.99879E−05 | 2.78162E−05 | 5.93088E−07 | −4.99133E−07 |
| Sixth order coefficient (B) | 3.17382E−08 | 2.65768E−10 | −1.40083E−08 | −2.29261E−08 | −2.24239E−10 | 1.99880E−10 |
| Eighth order coefficient (C) | | | 2.64942E−11 | 5.70701E−11 | 4.77209E−14 | 2.64871E−14 |
| Tenth order coefficient (D) | | | −3.97268E−13 | 6.99620E−14 | −2.34160E−18 | 1.79762E−18 |
| Twelfth order coefficient (E) | | | 6.01815E−16 | −8.24183E−16 | | |
| Fourteenth order coefficient (F) | | | | 1.03457E−18 | | |

TABLE 9
Odd-Order Aspherical Coefficient

| | S25 |
|---|---|
| Conic Constant | −1.80100 |
| Third Order Coefficient | 2.76805E−04 |
| Fourth Order Coefficient | −1.16087E−05 |
| Fifth Order Coefficient | −1.39800E−09 |
| Sixth Order Coefficient | 2.69829E−09 |
| Seventh Order Coefficient | 4.80577E−11 |
| Eighth Order Coefficient | −8.99884E−13 |
| Ninth Order Coefficient | −4.37036E−14 |
| Tenth Order Coefficient | 7.69461E−16 |

The following Table 10 indicates the numerical values of the angle θa, the angle θb, and the throw ratio TR, in each of the first and second examples. Note that, considering the fifth example (FIG. 8) of JP 2020-42103 A, the light ray of light emitting from the emitting surface 20C is angled in the clockwise direction with respect to the normal line (angle θb<0). Numerically calculating the throw ratio TR in the fifth example, TR=0.432. By contrast, in first example according to the embodiment, TR=0.215, and in second example, TR=0.180, and it can be seen that this is advantageous in achieving a wider field of view.

TABLE 10

| | First | Second |
|---|---|---|
| | Example | Example |
| Angle θa (degrees) | 33.3 | 42.2 |
| Angle θb (degrees) | 5.9 | 13.8 |
| Throw Ratio TR | 0.215 | 0.180 |

### Second Embodiment

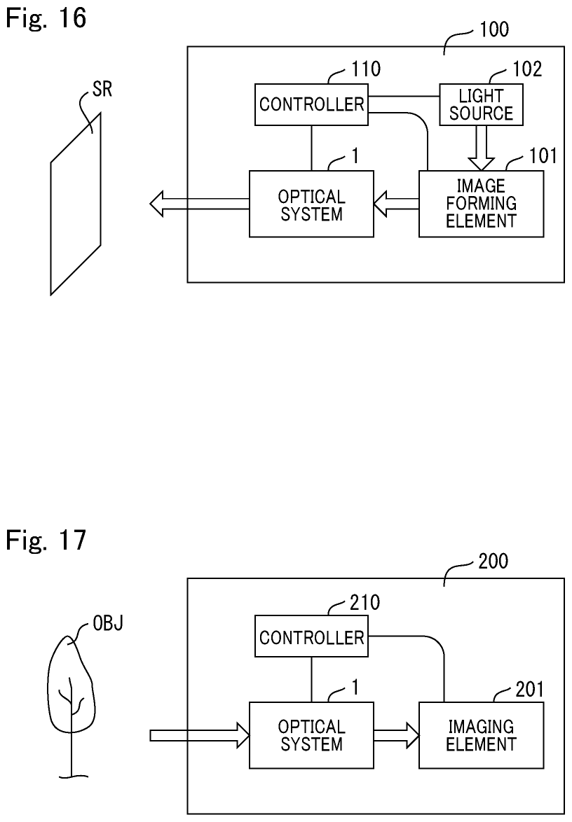

Hereinafter, a second embodiment of the present disclosure will be described with reference to FIG. 16. FIG. 16 is a block diagram illustrating an example of an image projection apparatus according to the present disclosure. The image projection apparatus 100 includes the optical system 1 disclosed in the first embodiment, an image forming element 101, a light source 102, a controller 110, and the like. The image forming element 101 includes a liquid crystal, a DMD, and the like, and generates an image to be projected onto the screen SR via the optical system 1. The light source 102 includes a light emitting diode (LED), a laser, and the like, and supplies light to the image forming element 101. The controller 110 includes a CPU, an MPU, and the like, and controls the entire device and each component. The optical system 1 may be configured as an interchangeable lens detachably attachable to the image projection apparatus 100, or may be configured as a built-in lens integrated with the image projection apparatus 100.

In the image projection apparatus 100 described above, the optical system 1 according to the first embodiment enables projection of a short focal and a large screen with a small device.

### Third Embodiment

Hereinafter, a third embodiment of the present disclosure will be described with reference to FIG. 17. FIG. 17 is a block diagram illustrating an example of an imaging apparatus according to the present disclosure. An imaging apparatus 200 includes the optical system 1 disclosed in the first embodiment, an imaging element 201, a controller 210, and the like. The imaging element 201 includes a charge coupled device (CCD) image sensor, a CMOS image sensor, and the like, and receives an optical image of an object OBJ formed by the optical system 1 and converts the optical image into an electrical image signal. The controller 110 includes a CPU, an MPU, and the like, and controls the entire apparatus and each component. The optical system 1 may be configured as an interchangeable lens detachably attachable to the imaging apparatus 200, or may be configured as a built-in lens integrated with the imaging apparatus 200.

In the imaging apparatus 200 described above, the optical system 1 according to the first embodiment enables imaging of a short focal and a large screen with a small device.

As described above, the embodiments have been described as the disclosure of the technique in the present disclosure. For this purpose, the accompanying drawings and the detailed description have been provided.

Therefore, the components described in the accompanying drawings and the detailed description may include not only components essential for solving the problem but also components that are not essential for solving the problem in order to exemplify the above technique. Therefore, it should not be immediately recognized that these non-essential components are essential on the basis of the fact that these non-essential components are described in the accompanying drawings and the detailed description.

In addition, since the above-described embodiments are intended to exemplify the technique in the present disclosure, various changes, replacements, additions, omissions, and the like can be made within the scope of the claims and equivalents thereof.

What is claimed is:

1. An optical system having a reduction conjugate point on a reduction side and a magnification conjugate point on a magnification side, and having an intermediate imaging position conjugate with each of the reduction conjugate point and the magnification conjugate point inside, the optical system comprising:
a first sub-optical system including a plurality of lenses that are rotationally symmetric with respect to an optical axis, and an aperture stop between two lenses among the plurality of lenses; and
a second sub-optical system disposed on the magnification side of the first sub-optical system and including a plurality of optical surfaces,
wherein, in a direction of the optical axis from the first sub-optical system to the second sub-optical system, a magnification conjugate plane including the magnification conjugate point is positioned in a direction of the first sub-optical system, from a viewpoint of the second sub-optical system, and
the plurality of optical surfaces include: on a light path of a light flux between the first sub-optical system and the magnification conjugate point,
a first transmitting surface located closest to the first sub-optical system;
a second transmitting surface located closest to the magnification conjugate point;
a first reflecting surface located closest to the first transmitting surface on the light path between the first transmitting surface and the second transmitting surface; and
a second reflecting surface located closest to the second transmitting surface on the light path between the first transmitting surface and the second transmitting surface, and
a light path from the first transmitting surface to the first reflecting surface and a light path from the second reflecting surface to the second transmitting surface intersect with each other, and
a first effective area through which the light flux passes in the first transmitting surface and a second effective area through which the light flux passes in the second transmitting surface do not overlap each other.

2. The optical system according to claim 1, wherein a principal ray of the light flux closest to the optical axis is reflected by the second reflecting surface at an angle θa of 30 degrees or more and less than 50 degrees with respect to the optical axis.

3. The optical system according to claim 1, wherein the first transmitting surface and the second transmitting surface are defined by curvatures or free-form surface coefficients that are different from each other, respectively.

4. The optical system according to claim 1, wherein, when a light ray travels within a YZ plane including a Z direction extending along the optical axis and a Y direction perpendicular to the Z direction, in the second sub-optical system, and
when a principal ray of the light flux closest to the optical axis passes through a first point of the second transmitting surface on the YZ plane, the principal ray travels outside the second sub-optical system in a direction closer to the first sub-optical system than a normal line of the second transmitting surface, the normal line passing through the first point of the second transmitting surface.

5. The optical system according to claim 1, wherein the first transmitting surface has a concave surface, from a viewpoint of the first sub-optical system.

6. The optical system according to claim 5, wherein the second transmitting surface has a convex surface, from a viewpoint of the magnification conjugate point.

7. The optical system according to claim 2, wherein the second reflecting surface has a convex surface, from a viewpoint of the second transmitting surface.

8. The optical system according to claim 1, wherein at least one of the first transmitting surface, the second transmitting surface, the first reflecting surface, and the second reflecting surface has a free-form surface.

9. The optical system according to claim 1, wherein the second sub-optical system includes a prism having the first transmitting surface, the second transmitting surface, the first reflecting surface, and the second reflecting surface.

10. The optical system according to claim 9, wherein the prism is made of a material having a refractive index of 1.5 or higher at a wavelength of 587.56 nm.

11. The optical system according to claim 9, wherein the intermediate imaging position is located inside the prism.

12. The optical system according to claim 1, wherein the magnification conjugate plane is positioned at an angle of 80 degrees or more and less than 100 degrees with respect to the optical axis.

13. An image projection apparatus comprising:
the optical system according to claim 1; and
an image forming element configured to generate an image to be projected onto a screen via the optical system.

14. An imaging apparatus comprising:
the optical system according to claim 1; and
an imaging element configured to receive an optical image formed by the optical system and to convert the optical image into an electrical image signal.
